(19) United States
(12) Patent Application Publication
(10) Pub. No.: US 2012/0039563 A1
(43) Pub. Date: Feb. 16, 2012

(54) METHOD FOR PRODUCING OPTICAL WAVEGUIDE, OPTICAL WAVEGUIDE, AND PHOTOELECTRIC COMPOSITE WIRING BOARD

(75) Inventors: Tomoaki Shibata, Ibaraki (JP); Toshihiro Kuroda, Ibaraki (JP); Masatoshi Yamaguchi, Ibaraki (JP); Shigeyuki Yagi, Ibaraki (JP); Hiroshi Masuda, Ibaraki (JP)

(73) Assignee: Hitachi Chemical Company, Ltd., Tokyo (JP)

(21) Appl. No.: 13/146,257

(22) PCT Filed: Jan. 27, 2010
(86) PCT No.: PCT/JP2010/051060

§ 371 Date: Oct. 6, 2011

(30) Foreign Application Priority Data
Jan. 28, 2009 (JP) 2009-017180
Jan. 28, 2009 (JP) 2009-017181

(51) Int. Cl. G02B 6/12; B44C 3/02; G02B 6/02

(52) U.S. Cl. 385/14; 385/123; 156/219

(57) ABSTRACT

(1) A method for producing a flexible optical waveguide, containing: a step of forming a first cladding layer; a step of forming a first core layer by laminating a resin film for forming a core layer on at least one end portion of the first cladding layer; a step of forming a second core layer by laminating a resin film for forming a core layer on an entire surface of the first core layer and the first cladding layer; a step of forming a core pattern by patterning the first and second core layers; and a step of embedding the core pattern by forming a second cladding layer on the core pattern and the first cladding layer, (2) a flexible optical waveguide containing a lower cladding layer, a core part and an upper cladding layer, the upper cladding layer having a width that is smaller than a width of the lower cladding layer at least in a bent portion, and is equal to or smaller than a width of the lower cladding layer in an end portion, and the lower cladding layer having a width in a bent portion that is equal to or smaller than a width thereof in an end portion, and a method for producing the same. A flexible optical waveguide that is excellent in bending durability and has small optical loss, and a method for producing the same.

### TECHNICAL FIELD

The present invention relates to a flexible optical waveguide that is excellent in bending durability and is excellent in light transmission characteristics, a method for producing the same, and an optoelectronic circuit board using the flexible optical waveguide.

### BACKGROUND ART

In the high-speed and high-density signal transmission among electronic devices and circuit boards in recent years, the signal transfer with a conventional electric circuit is now encountering limitation in enhancement of the speed and density due to the barriers including mutual interference and attenuation of the signals. For breaking down the barriers, a technique of connecting electronic devices and circuit boards with light, i.e., the so-called optical interconnection, is being investigated. A polymer optical waveguide is receiving attention owing to the easiness in processing as a transmission path of light, the low cost, the high degree of freedom in wiring, and the capability of high-density wiring. In particular, an optical waveguide is being considered to be used in a mobile telephone, a notebook computer and the like.

In the case where a flexible optical waveguide is used for signal transmission between two openable working sections of an electronic device, such as a mobile telephone, there are cases where the flexible optical waveguide crosses the connecting portion (i.e., the hinge) between the two working sections. In this case, the flexible optical waveguide is bent with the hinge and may suffer breakage and cracks due to bending. In particular, a small bending radius of approximately from 1 to 2 mm is required at the hinge owing to the demand of size reduction of electronic devices in recent years, and there arises a problem that the breakage and cracks frequently occur at the hinge.

A photoelectric mixed circuit board containing an optical wiring and an electric wiring combined is particularly demanded for saving spaces and reducing thickness, and a flexible optical waveguide is demanded to have higher bending durability since the photoelectric mixed circuit board has an increased thickness.

The thickness of the bent portion of a flexible optical waveguide may be decreased as a method for enhancing the bending durability thereof, but for decreasing the thickness of the flexible optical waveguide, it is necessary to reduce the core size of the flexible optical waveguide. It is considered that the reduction of the core size may lower the optical coupling efficiency, and thus a flexible optical waveguide having a portion that has a smaller thickness than the light input part is proposed (see Patent Document 1).

Patent Document 1 proposes, as a method for producing the aforementioned flexible optical waveguide, a production method is proposed, containing a step of coating a solution of a core material, a cladding material, or a precursor thereof by using an applicator equipped with an applicator head having a film thickness controlling part, and a step removing a part of the coated solution.

In the aforementioned method using a solution, however, it is difficult to control the film thickness, and it is difficult to control the tilt of the core part since the coated solution is leveled after performing the step of removing a part of the solution.

In the technique disclosed in Patent Document 1, the bending durability of the optical waveguide is enhanced by decreasing the thickness of the upper cladding at the bent portion without changing the core size, but it is not necessarily easy to control the thickness of a part of the upper cladding layer, and thus a method capable of enhancing the bending durability conveniently has been demanded.

### RELATED ART

### Document

### Patent Document

Patent Document 1: WO 2007/026601

### SUMMARY OF THE INVENTION

### Problems to be solved by the Invention

In view of the problems, an object of the present invention is to provide a flexible optical waveguide that is excellent in bending durability and is excellent in light transmission characteristics, a method for producing the same, and an optoelectronic circuit board using the flexible optical waveguide.

### Means for solving the Problems

As a result of earnest investigations made by the inventors, it has been found that the problems can be solved by laminating resin films for forming a core layer in two layers on a cladding layer in an end portion, or by making a width of an upper cladding layer smaller than a width of a lower cladding layer in a bent portion of an optical waveguide.

The present invention provides a first embodiment relating to:

(1) a method for producing a flexible optical waveguide, containing: (I) a step of forming a first cladding layer; (II) a step of forming a first core layer by laminating a resin film for forming a core layer on at least one end portion of the first cladding layer; (III) a step of forming a second core layer by laminating a resin film for forming a core layer on an entire surface of the first core layer and the first cladding layer; (IV) a step of forming a core pattern of the optical waveguide by patterning the first core layer and the second core layer; and (V) a step of embedding the core pattern by forming a second cladding layer on the core pattern and the first cladding layer,

(2) a flexible optical waveguide produced by the production method according to the item (1), and

(3) an optoelectronic circuit board containing the flexible optical waveguide according to the item (2) laminated on a flexible electric circuit board.

The present invention also provides a second embodiment relating to:

(1) a flexible optical waveguide containing a lower cladding layer, a core part and an upper cladding layer, the upper cladding layer having a width that is smaller than a width of the lower cladding layer at least in a bent portion, and is equal to or smaller than a width of the lower cladding layer in an end portion, and the lower cladding layer having a width in a bent portion that is equal to or smaller than a width thereof in an end portion,

(2) a method for producing a flexible optical waveguide, containing (i) a step of forming a lower cladding layer; (ii) a step of forming a core layer on the lower cladding layer; (iii) a step of forming a core pattern of the optical waveguide by patterning the core layer; (iv) a step of embedding the core pattern by laminating a resin for forming a cladding layer on the lower cladding layer and the core pattern; and (v) a step of forming an upper cladding layer having a width that is smaller than a width of the lower cladding layer at least in a bent portion, by exposing and developing the resin for forming a cladding layer, while maintaining the core pattern embedded, and

(3) an optoelectronic circuit board containing the flexible optical waveguide according to the item (2) laminated on a flexible electric circuit board.

### Advantages of the Invention

According to the present invention, a flexible optical waveguide that is excellent in bending durability and is excellent in light transmission characteristics, a method for producing the same, and an optoelectronic circuit board using the flexible optical waveguide are provided.

### BRIEF DESCRIPTION OF THE DRAWINGS

FIG. 1 The figure is a schematic illustration showing steps of a production method according to the first embodiment of the present invention.

FIG. 2 The figure is an illustration describing a resin film for forming a cladding layer used in production of a flexible optical waveguide of the present invention.

FIG. 3 The figure is an illustration describing a resin film for forming a core layer used in production of a flexible optical waveguide of the present invention.

FIG. 4 The figure is a schematic illustration showing a part of steps of a production method according to the first embodiment of the present invention.

FIG. 5 The figure is a schematic illustration showing one embodiment of a flexible optical waveguide obtained by a production method according to the first embodiment of the present invention.

FIG. 6 The figure is a schematic illustration showing another embodiment of a flexible optical waveguide obtained by a production method according to the first embodiment of the present invention.

FIG. 7 The figure is a schematic illustration showing still another embodiment of a flexible optical waveguide obtained by a production method according to the first embodiment of the present invention.

FIG. 8 The figure is a schematic illustration showing a further embodiment of a flexible optical waveguide obtained by a production method according to the first embodiment of the present invention.

FIG. 9 The figure is a schematic illustration showing an optical waveguide according to the second embodiment of the present invention viewed in the waveguide direction.

FIG. 10 The figure is a phantom view showing an optical waveguide according to the second embodiment of the present invention viewed from the side of the upper cladding layer.

FIG. 11 The figure is a phantom view showing an optical waveguide according to the second embodiment of the present invention viewed from the side of the upper cladding layer.

FIG. 12 The figure is a schematic illustration showing steps of a production method according to the second embodiment of the present invention.

FIG. 13 The figure is a conceptual illustration showing contents of a bending durability test.

FIG. 14 The figure shows results of the measurement of the film thickness of the flexible optical waveguide produced in Example 1.

FIG. 15 The figure shows results of the measurement of the film thickness of the flexible optical waveguide produced in Example 2.

FIG. 16 The figure is an illustration describing the optical waveguide produced in Example 3.

### MODE FOR CARRYING OUT THE INVENTION

### Method for Producing Flexible Optical Waveguide According to First Embodiment of the Present Invention

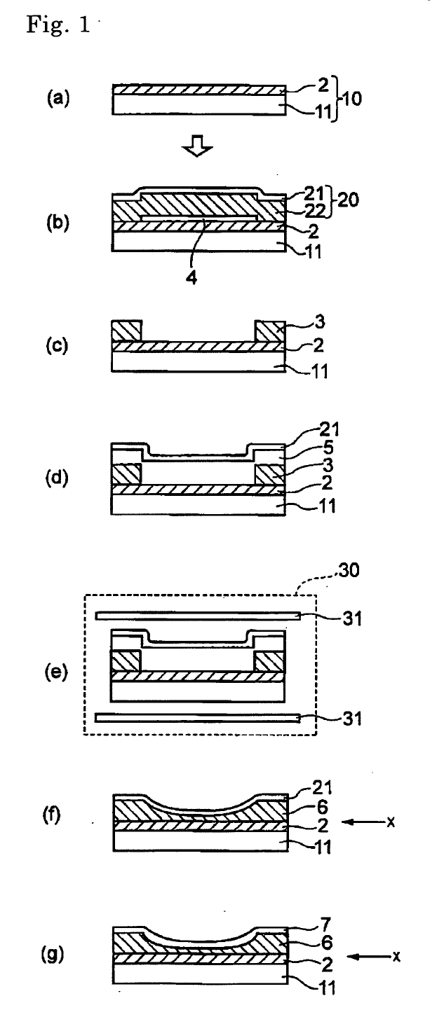

The method for producing a flexible optical waveguide according to the first embodiment of the present invention contains the steps (I) to (V). The steps will be respectively described below with reference to FIG. 1.

In the production method according to the first embodiment of the present invention, upon forming a cladding layer and a core layer, the layers may be laminated by coating a resin for forming the cladding layer or the core layer by a spin coating method or the like, but it is preferred to use a resin film for forming a cladding layer and a resin film for forming a core layer. The use of the films facilitates control of the film thickness and enhances the handleability. The step diagram shown in FIG. 1 describes the case using the resin films.

### Step (I)

The step (I) in the production method according to the first embodiment of the present invention is a step of forming a first cladding layer. The method of forming the first cladding layer includes various methods, and is preferably a method of curing a resin for forming a cladding layer of a resin film for forming a cladding layer, thereby forming the first cladding layer (lower cladding layer) 2, as shown in FIG. 1(a).

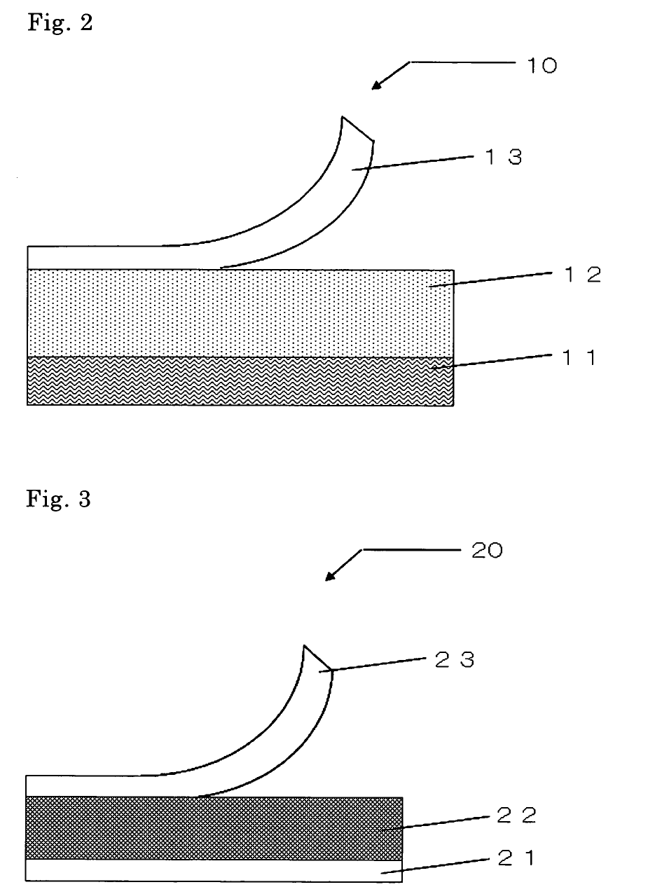

The resin film for forming a cladding layer 10 used herein contains a base film 11 having a resin for forming a cladding layer 12 coated thereon, as shown in FIG. 2, and may have a structure containing a protective film (separator) 13 laminated thereon depending on necessity.

The protective film may be provided upon producing the resin film for forming a cladding layer, for such purposes as protection of the resin film for forming a cladding layer and enhancement of the winding property thereof upon producing the resin film in a roll form, and the protective film used may be the same materials as those exemplified for the base film described later. The protective film is preferably not subjected to an adhesion treatment, such as a corona treatment, for facilitating release from the resin film for forming a cladding layer, and may be subjected to a release treatment and an antistatic treatment depending on necessity.

The base film 11 is coated with the resin for forming a cladding layer 12 and becomes a supporting base in the production of an optical waveguide later. The material therefor is not particularly limited, and preferred examples of the material include polyester, such as polyethylene terephthalate, polybutylene terephthalate and polyethylene naphthalate, polyethylene, polypropylene, polyamide, polycarbonate, polyphenylene ether, polyether sulfide, polyphenylene sulfide, polyarylate, a liquid crystal polymer, polysulfone, polyether sulfone, polyether ether ketone, polyetherimide, polyamideimide, polyimide and aramid, from the standpoint of the flexibility and toughness thereof.

Among the base films, polyester, such as polyethylene terephthalate and polyethylene naphthalate, polyamide, polyphenylene sulfide and aramid are preferably used as the base film for producing the optical waveguide, owing to the factors including the heat resistance and the developer solution resistance enabling the production of the optical waveguide, the ultraviolet ray transmissibility for curing the cladding layer, and the availability. In particular, an aramid film, a polyamide film, a polyethylene naphthalate film and a polyphenylene sulfide film are preferred from the standpoint of the heat resistance and the low contraction degree upon producing the optical waveguide, and a polyethylene naphthalate film is preferred from the standpoint of the ultraviolet ray transmissibility for curing the cladding layer.

The surface of the base film may be subjected to a treatment for enhancing the adhesiveness to the resin for forming a cladding layer 12 and the like, and examples of the treatment include a physical or chemical surface treatment, such as an oxidizing method and a roughening method. Examples of the oxidizing method include a corona treatment, a chromic acid treatment, a flame treatment, a hot air treatment and an ozone and ultraviolet ray treatment, and examples of the roughening method include a sand blasting method and a solvent treating method.

In the step (I), in the case where the protective film 13 is provided on the side of the resin film for forming a cladding layer opposite to the base film (see FIG. 2), the protective film is released off, and then the resin film for forming a cladding layer is cured with light (such as ultraviolet ray (UV)) or heat, thereby forming a first cladding layer (lower cladding layer) 2.

The resin for forming a cladding layer used in the first embodiment of the present invention is not particularly limited as far as it is a resin composition that has a lower refractive index than a core layer and is capable of being cured with light or heat, and a thermosetting resin composition and a photosensitive resin composition may be used.

It is more preferred that the resin for forming a cladding layer is constituted by a resin composition that contains (A) a base polymer, (B) a photo- or heat-polymerizable compound and (C) a photo- or heat-polymerization initiator.

The base polymer (A) used herein is for forming the cladding layer for ensuring the strength of the cladding layer, and is not particularly limited as far as the object is achieved, and examples thereof include a phenoxy resin, an epoxy resin, a (meth) acrylic resin, a polycarbonate resin, a polyarylate resin, polyetheramide, polyetherimide, polyethersulfone and derivatives of them. The base polymers may be used solely or as a mixture of two or more kinds of them.

In the base polymers exemplified above, one having an aromatic skeleton is preferred from the standpoint of the high heat resistance thereof, and a phenoxy resin is particularly preferred.

An epoxy resin, and particularly an epoxy resin that is in a solid state at room temperature, is preferred since it can be three-dimensionally crosslinked to enhance the heat resistance. Furthermore, the compatibility with the photo- or heat-polymerizable compound (B) described later is important for ensuring the transparency of the resin film for forming a cladding layer, and a phenoxy resin and a (meth) acrylic resin are preferred in this point of view. The (meth) acrylic resin referred herein means an acrylic resin and a methacrylic resin.

In the phenoxy resin, one having, as a constitutional unit of the copolymerization components, bisphenol A or a bisphenol A type epoxy compound, or a derivative of them, and bisphenol F or a bisphenol F type epoxy compound, or a derivative of them are preferred since it is excellent in heat resistance, adhesiveness and solubility. Preferred examples of a derivative of bisphenol A or a bisphenol A type epoxy compound include tetrabromobisphenol A and a tetrabromobisphenol A type epoxy compound. Preferred examples of a derivative of bisphenol F or a bisphenol F type epoxy compound include tetrabromobisphenol F and a tetrabromobisphenol F type epoxy compound. Specific examples of a bisphenol A/bisphenol F copolymer type phenoxy resin include “Phenotohto YP-70”, a trade name, produced by Tohto Kasei Co., Ltd.

Examples of the epoxy resin that is in a solid state at room temperature include bisphenol A type epoxy resins, such as “Epotohto YD-7020”, “Epotohto YD-7019” and “Epotohto YD-7017”, all trade names, produced by Tohto Kasei Co., Ltd., and “Epikote 1010”, “Epikote 1009” and “Epikote 1008”, all trade names, produced by Japan Epoxy Resin Co., Ltd.

The molecular weight of the base polymer (A) is preferably 5,000 or more, more preferably 10,000 or more, and particularly preferably 30,000 or more, in terms of number average molecular weight, from the standpoint of the formability of the film. The upper limit of the number average molecular weight is not particularly limited, and is preferably 1,000,000 or less, more preferably 500,000 or less, and particularly preferably 200,000 or less, from the standpoint of the compatibility with the photo- or heat-polymerizable compound (B) and the photo- or heat-curing property (exposing and developing property). The number average molecular weight referred in the present invention is a value obtained by measuring with gel permeation chromatography (GPC) and converting based on the standard polystyrene.

The amount of the base polymer (A) mixed is preferably from 10 to 80% by mass based on the total amount of the component (A) and the component (B). When the mixed amount is 10% by mass or more, an advantage is provided that the production of a film having a thickness of approximately from 50 to 500 μm, which is necessary for forming an optical waveguide, is facilitated, and when the amount is 80% by mass or less, the photo- or heat-curing reaction proceeds sufficiently. The amount of the base polymer (A) mixed is more preferably from 20 to 70% by mass from this point of view.

The photo- or heat-polymerizable compound (B) is not particularly limited as far as it is polymerized through irradiation of light, such as an ultraviolet ray, or heat, and examples thereof include a compound having two or more epoxy groups in the molecule thereof and a compound having an ethylenic unsaturated group in the molecule thereof.

Specific examples of the compound having two or more epoxy groups in the molecule thereof include a bifunctional aromatic glycidyl ether, such as a bisphenol A type epoxy resin, a tetrabromobisphenol A type epoxy resin, a bisphenol F type epoxy resin, a bisphenol AD type epoxy resin and a naphthalene type epoxy resin; a polyfunctional aromatic glycidyl ether, such as a phenol-novolac type epoxy resin, a cresol-novolac type epoxy resin, a dicyclopentadiene-phenol type epoxy resin and a tetraphenylolethane type epoxy resin; a bifunctional aliphatic glycidyl ether, such as a polyethylene glycol type epoxy resin, a polypropylene glycol type epoxy resin, a neopentyl glycol type epoxy resin and a hexanediol type epoxy resin; a bifunctional alicyclic glycidyl ether, such as a hydrogenated bisphenol A type epoxy resin; a polyfunctional aliphatic glycidyl ether, such as a trimethylolpropane type epoxy resin, a sorbitol type epoxy resin and a glycerin type epoxy resin; a bifunctional aromatic glycidyl ester, such as diglycidyl phthalate; a bifunctional alicyclic glycidyl ester, such as diglycidyl tetrahydrophthalate and diglycidyl hexahydrophthalate; a bifunctional aromatic glycidyl amine, such as N,N-diglycidylaniline and N,N-diglycidyltrifluoromethylaniline; a polyfunctional aromatic glycidyl amine, such as N,N,N′,N′-tetraglycidyl-4,4-diaminodiphenylmethane, 1,3-bis(N,N-glycidylaminomethyl)cyclohexane and N,N,O-triglycidyl-p-aminophenol; a bifunctional alicyclic epoxy resin, such as an alicyclic diepoxy acetal, an alicyclic diepoxy adipate, an alicyclic diepoxy carboxylate and vinylcyclohexene dioxide; a bifunctional heterocyclic epoxy resin, such as diglycidylhydantoin; a polyfunctional heterocyclic epoxy resin, such as triglycidyl isocyanurate; and a bifunctional or polyfunctional silicon-containing epoxy resin, such as an organopolysiloxane type epoxy resin.

The compound having two or more epoxy groups in the molecule thereof generally has a molecular weight of approximately from 100 to 2,000, and more preferably approximately from 150 to 1,000, and the compound that is in a liquid state at room temperature is preferably used. The compound may be used solely or as a combination of two or more kinds thereof, and may also be used as a combination with another photo- or heat-polymerizable compound. The molecular weight of the photo- or heat-polymerizable compound in the present invention may be measured by a GPC method or a mass spectrometry method.

Specific examples of the compound having an ethylenic unsaturated group in the molecule thereof include a (meth)acrylate, a halogenated vinylidene, vinyl ether, vinylpyridine and vinylphenol, and among these, a (meth)acrylate is preferred from the standpoint of the transparency and the heat resistance, which may be a monofunctional compound, a bifunctional compound or a trifunctional or higher functional compound.

Examples of the monofunctional (meth)acrylate include methoxypolyethylene glycol (meth)acrylate, phenoxypolyethylene glycol (meth)acrylate, lauryl (meth)acrylate, isostearyl (meth)acrylate, 2-(meth)acryloyloxyethyl succinate, p-cumylphenoxyethylene glycol (meth)acrylate, 2-tetrahydropyranyl (meth)acrylate, isobornyl (meth)acrylate, methyl (meth)acrylate, ethyl (meth)acrylate, butyl (meth)acrylate and benzyl (meth)acrylate.

Examples of the bifunctional (meth)acrylate include ethoxylated 2-methyl-1,3-propanediol di(meth)acrylate, neopentyl glycol di(meth)acrylate, 1,6-hexanediol di(meth)acrylate, 2-methyl-1,8-octanediol diacrylate, 1,9-nonanediol di(meth)acrylate, 1,10-nonanediol di(meth)acrylate, ethoxylated polypropylene glycol di(meth)acrylate, propoxylated ethoxylated bisphenol A diacrylate, ethylene glycol di(meth)acrylate, triethylene glycol di(meth)acrylate, tetraethylene glycol di(meth)acrylate, polyethylene glycol di(meth)acrylate, polypropylene glycol di(meth)acrylate, ethoxylated bisphenol A di(meth)acrylate, tricyclodecane di(meth)acrylate, ethoxylated cyclohexanedimethanol di(meth)acrylate, 2-hydroxy-1-acryloxy-3-methacryloxypropane, 2-hydroxy-1,3-dimethacryloxypropane, 9,9-bis[4-(2-acryloyloxyethoxy)phenyl]fluorene, 9,9-bis(3-phenyl-4-acryloylpolyoxyethoxy)fluorene, and bisphenol A type, phenol-novolac type, cresol-novolac type and glycidyl ether type epoxy (meth)acrylates.

Examples of the trifunctional or higher functional (meth)acrylate include ethoxylated isocyanuric acid tri(meth)acrylate, ethoxylated glycerin tri(meth)acrylate, trimethylolpropane tri(meth)acrylate, ethoxylated trimethylolpropane tri(meth)acrylate, pentaerythritol tri(meth)acrylate, pentaerythritol tetra(meth)acrylate, ethoxylated pentaerythritol tetra(meth)acrylate, propoxylated pentaerythritol tetra(meth)acrylate, ditrimethylolpropane tetra(meth)acrylate, caprolactone-modified ditrimethylolpropane tetraacrylate and dipentaerythritol hexa(meth)acrylate. These may be used solely or as a combination of two or more kinds thereof.

The term (meth)acrylate herein means acrylate and methacrylate. The amount of the photo- or heat-polymerizable compound (B) mixed is preferably from 20 to 90% by mass based on the total amount of the component (A) and the component (B). When the mixed amount is 20% by mass or more, the compound can be easily cured with the base polymer entrained thereby, and when it is 90% by mass or less, a cladding layer having a sufficient thickness can be easily formed. The amount of the photo- or heat-polymerizable compound (B) mixed is more preferably from 30 to 80% by mass from this point of view.

The photo- or heat-polymerization initiator (C) is not particularly limited, and examples of the initiator for the epoxy compound include an aryl diazonium salt, such as p-methoxybenzene diazonium hexafluorophosphate; a diaryl iodonium salt, such as diphenyl iodonium hexafluorophosphonium salt and diphenyl iodonium hexafluoroantimonate; a triaryl sulfonium salt, such as triphenyl sulfonium hexafluorophosphonium salt, triphenyl sulfonium hexafluoroantimonate salt, diphenyl-4-thiophenoxyphenyl sulfonium hexafluoroantimonate salt, diphenyl-4-thiophenoxyphenyl sulfonium hexafluoroantimonate salt and diphenyl-4-thiophenoxyphenyl sulfonium pentafluorohydroxyantimonate salt; a triaryl selenonium salt, such as triphenyl selenonium hexafluorophosphonium salt, triphenyl selenonium fluoroborate salt and triphenyl selenonium hexafluoroantimonate salt; a dialkyl phenacylsulfonium salt, such as dimethyl phenacylsulfonium hexafluoroantimonate salt and diethyl phenacylsulfonium hexafluoroantimonate salt; a dialkyl-4-hydroxyphenyl sulfonium salt, such as 4-hydroxyphenyl dimethylsulfonium hexafluoroantimonate salt and 4-hydroxyphenyl benzylmethylsulfonium hexafluoroantimonate salt; and a sulfonate ester, such as α-hydroxymethylbenzoin sulfonate ester, N-hydroxyimide sulfonate, α-sulfonyloxy ketone and β-sulfonyloxy ketone.

An initiator for the compound having an ethylenic unsaturated group in the molecule thereof may also be used, and examples thereof include an aromatic ketone compound, such as benzophenone, N,N′-tetramethyl-4,4′-diaminobenzophenone (Michler's ketone), N,N′-tetraethyl-4,4′-diaminobenzophenone, 4-methoxy-4′-dimethylaminobenzophenone, 2-benzyl-2-dimethylamino-1-(4-morpholinophenyl)butan-1-one, 2,2-dimethoxy-1,2-diphenylethan-1-one, 1-hydroxycyclohexyl phenyl ketone, 2-hydroxy-2-methyl-1-phenylpropan-1-one, 1-[4-(2-hydroxyethoxy)phenyl]-2-hydroxy-2-methyl-1-propan-1-one and 1,2-methyl-1-[4-(methylthio)phenyl]-2-morpholino-propan-1-one; a quinone compound, such as 2-ethylanthraquinone, phenanthrenequinone, 2-tert-butylanthraquinone, octamethylanthraquinone, 1,2-benzanthraquinone, 2,3-benzanthraquinone, 2-phenylanthraquinone, 2,3-diphenylanthraquinone, 1-chloroanthraquinone, 2-methylanthraquinone, 1,4-naphthoquinone, 9,10-phenanthraquinone, 2-methyl-1,4-naphthoquinone and 2,3-dimethylanthraquinone; a benzoin ether compound, such as benzoin methyl ether, benzoin ethyl ether and benzoin phenyl ether; a benzoin compound, such as benzoin, methylbenzoin and ethylbenzoin; a benzyl derivative, such as benzyl dimethyl ketal; a 2,4,5-triarylimidazole dimer, such as 2-(o-chlorophenyl)-4,5-diphenylimidazole dimer, 2-(o-chlorophenyl)-4,5-di(methoxyphenyl)imidazole dimer, 2-(o-fluorophenyl)-4,5-diphenylimidazole dimer, 2-(o-methoxyphenyl)-4,5-diphenylimidazole dimer and 2-(p-methoxyphenyl)-4,5-diphenylimidazole dimer; a phosphine oxide compound, such as bis(2,4,6-trimethylbenzoyl)phenylphosphine oxide, bis(2,6-dimethoxybenzoyl)-2,4,4-trimethylpentylphosphine oxide and 2,4,6-trimethylbenzoylphenyl phosphine oxide; an acridine derivative, such as 9-phenylacridine and 1,7-bis(9,9′-acrydinyl)heptane; N-phenylglycine; an N-phenylglycine derivative; and a coumarin compound. In the 2,4,5-triarylimidazole dimer, the aryl groups on two 2,4,5-triarylimidazole moieties may be the same as each other to provide a symmetrical compound, or may be different from each other to provide an asymmetrical compound. A combination of a thioxanthone compound and a tertiary amine compound, such as a combination of diethylthioxanthone and dimethylaminobenzoic acid, may be used. Among the compounds, an aromatic ketone compound and a phosphine oxide compound are preferred from the standpoint of enhancement of the transparency of the core layer and the cladding layer. The photo- or heat-polymerization initiator (C) may be used solely or as a combination of two or more kinds thereof.

The amount of the photo- or heat-polymerization initiator (C) mixed is preferably from 0.1 to 10 parts by mass per 100 parts by mass in total of the component (A) and the component (B). When the amount is 0.1 part by mass or more, sufficient sensitivity to light or heat can be obtained, and when it is 10 parts by mass or less, only the surface of the optical waveguide is selectively cured favorably with preventing insufficient curing, and the transmission loss due to absorption of the photo- or heat-polymerization initiator itself is favorably not increased. The amount of the photo- or heat-polymerization initiator (C) mixed is more preferably from 1 to 5 parts by mass.

The resin for forming a cladding layer of the present invention may further contain, depending on necessity, so-called additives, such as an antioxidant, a yellowing preventing agent, an ultraviolet ray absorbent, a visible light absorbent, a colorant, a plasticizer, a stabilizer and a filler, in such an amount that does not impair the advantages of the present invention.

The resin film for forming a cladding layer can be easily produced in such a manner that the resin composition containing the components (A) to (C) is dissolved in a solvent and coated on the base film, and then the solvent is removed. The solvent used herein is not particularly limited as far as it dissolves the resin composition, and examples of the solvent include acetone, methyl ethyl ketone, methyl cellosolve, ethyl cellosolve, toluene, N,N-dimethylacetamide, propylene glycol monomethyl ether, propylene glycol monomethyl ether acetate, cyclohexanone and N-methyl-2-pyrrolidone, and a mixed solvent thereof. The solid concentration in the resin solution is preferably approximately from 30 to 80% by mass.

The thickness of the first cladding layer is preferably in a range of from 5 to 500 μm after drying. When the thickness is 5 μm or more, the thickness that is required for confinement of light is ensured, and when it is 500 μm or less, the film thickness can be easily controlled uniformly. The thickness of the cladding layer is more preferably in a range of from 10 to 100 μm in this point of view.

The thickness of the first cladding layer (i.e., the lower cladding layer) firstly formed and the thickness of the second cladding layer (i.e., the upper cladding layer) for embedding the core pattern described later may be the same as each other or may be different from each other, and the thickness of the second cladding layer (i.e., the upper cladding layer) is preferably larger than the thickness of the core layer, for embedding the core pattern.

### Step (II)

The step (II) in the production method according to the first embodiment of the present invention is a step of forming a first core layer by laminating a resin film for forming a core layer on at least one end portion of the first cladding layer (i.e., the lower cladding layer). The first core layer may be provided on at least one end portion of the first cladding layer, and is preferably provided on both end portions as shown in FIG. 1(c) from the standpoint of the structural symmetry.

As a method of forming the first core layer by laminating a resin film for forming a core layer, the resin film for forming a core layer is cut into a necessary size in advance, and is adhered to one end or both ends by heat pressing or through an adhesive or a pressure-sensitive adhesive.

Furthermore, as shown in FIG. 1(b), the first core layer may be formed in the following manner. A masking film 4 is disposed on the portion other than the end portions (the portion other than the end portions is hereinafter referred to as an “intermediate portion”). The resin film for forming a core layer 20 is laminated on the entire surface of the first cladding layer 2 including the portion having the masking film 4 disposed and the portion having no masking film disposed, and then the resin film for forming a core layer on the masking film is removed along with the masking film (see FIG. 1(c)).

This method is efficient and preferred since the method does not require a step of cutting the resin film for forming a core layer in advance, as compared to the method using the resin film for forming a core layer that has been cut into the necessary size, and contains only one step of laminating the resin film for forming a core layer.

The end portion referred in the present invention designates the portion that does not cover the bent portion. The length thereof may freely vary depending on the design, and is preferably approximately from 3 to 20% of the total length of the optical waveguide, from one edge of the optical waveguide in the waveguide direction, from the standpoint of the handleability.

The masking film 4 is not particularly limited as far as it can be easily released from the first cladding layer 2. A material that is similar to those exemplified for the base film of the resin film for forming a cladding layer may be used therefor, and a polyester film, such as a PET film, is preferably used from the standpoint of the handleability.

The masking film is preferably not subjected to an adhesion treatment, such as a corona treatment, for facilitating release from the cladding layer 2, and may be subjected to a release treatment and an antistatic treatment depending on necessity.

The resin film for forming a core layer used in the present invention may be one containing a base film having a resin for forming a core layer coated thereon, or one constituted solely by a resin for forming a core layer, and one containing a base film having a resin for forming a core layer formed thereon is preferred owing to the good handleability thereof. More specifically, one having a structure shown in FIG. 3 may be used, which contains a base film 21 having a resin for forming a core layer 22 formed thereon, and may further have a protective film 23 on the opposite side to the base film 21 depending on necessity for such purposes as protection of the resin film for forming a core layer and enhancement of the winding property thereof upon producing the resin film in a roll form. The protective film may be one that is similar to those exemplified for the base film of the resin film for forming a cladding layer.

The protective film and the base film are preferably not subjected to an adhesion treatment, such as a corona treatment, for facilitating release from the resin film for forming a core layer, and may be subjected to a release treatment and an antistatic treatment depending on necessity.

Upon laminating the resin film for forming a core layer 20, the resin film for forming a core layer is preferably laminated under reduced pressure from the standpoint of the adhesiveness and the followability. The heating temperature thereon is preferably from 50 to 130° C., and the pressing pressure is preferably approximately from 0.1 to 1.0 MPa (from 1 to 10 kgf/cm²). These conditions are not particularly limited.

The film is preferably laminated with a roll laminator from the standpoint of preventing bubbles from being entrained between the first cladding layer and the core layer.

The resin film for forming a core layer used in the present invention is designed in such a manner that the core layer has a higher refractive index than the cladding layer, and may be formed of a resin composition capable of forming a core pattern with active light, and a photosensitive resin composition is preferably used. Specifically, a resin composition that is similar to one used in the resin for forming a cladding layer is preferably used. The resin composition may contain the components (A), (B) and (C) and may further contain the arbitrary components depending on necessity.

The resin film for forming a core layer can be easily produced in such a manner that the resin composition containing the components (A) to (C) is dissolved in a solvent and coated on the base film, and then the solvent is removed. The solvent used herein is not particularly limited as far as it dissolves the resin composition, and examples of the solvent include acetone, methyl ethyl ketone, methyl cellosolve, ethyl cellosolve, toluene, N,N-dimethylformamide, N,N-dimethylacetamide, propylene glycol monomethyl ether, propylene glycol monomethyl ether acetate, cyclohexanone and N-methyl-2-pyrrolidone, and a mixed solvent thereof. It is preferred that the solid concentration in the resin solution is generally approximately from 30 to 80% by mass.

The thickness of the resin film for forming a core layer is not particularly limited and may be appropriately determined corresponding to the thickness of the core layer after drying. The optical waveguide obtained in the present invention are different in the thickness of the core layer between at least one end portion and the portion other than the end portion (i.e., the intermediate portion), and the thickness of the resin film for forming a core layer used in the step (II) and the step (III) is controlled to provide the desired thickness.

The optical waveguide obtained in the first embodiment of the present invention is generally controlled to have a thickness of the core layer of from 10 to 100 μm at the end portion. When the thickness of the core layer is 10 μm or more, such an advantage is obtained that the positioning tolerance upon coupling with a light receiving device or an optical fiber after forming the optical waveguide can be enhanced, and when it is 100 μm or less, such an advantage is obtained that the coupling efficiency upon coupling with a light receiving device or an optical fiber after forming the optical waveguide can be enhanced. The thickness of the core layer at the end portion is more preferably in a range of from 30 to 70 μm in this point of view.

The thickness of the core layer at the intermediate portion is advantageously as thin as possible for the bending durability, and may be necessarily a certain thickness for preventing the optical loss from being increased. The minimum thickness of the core layer at the intermediate portion is preferably in a range of from 30 to 80%, and more preferably in a range of from 40 to 60%, of the thickness thereof at the end portion in this point of view.

The material for the base film in the case where the resin film for forming a core layer contains the base film having a resin for forming a core layer formed thereon, and the material for the base film for producing the resin film for forming a core layer in the case where the resin film for forming a core layer is constituted solely by the resin for forming a core layer are not particularly limited, and preferred examples of the materials include polyester, such as polyethylene terephthalate, polypropylene and polyethylene, from the standpoint of the easiness in release in the later step, the heat resistance and the solvent resistance.

The thickness of the base film is preferably from 5 to 50 μm. When the thickness is 5 μm or more, such an advantage is obtained that the strength as a supporting member may be easily obtained, and when it is 50 μm or less, such an advantage is obtained that the distance to a mask upon forming the pattern is decreased to facilitate formation of a more minute pattern. The thickness of the base film is more preferably from 10 to 40 μm, and particularly preferably from 15 to 30 μm, in this point of view.

A highly transparent flexible base material is preferably used for enhancement of the transmittance of light for exposure and prevention of roughening on the side wall of the core pattern. The highly transparent base film preferably has a haze value of 5% or less, more preferably 3% or less, and particularly preferably 2% or less. The haze value is measured according to JIS K7105, and can be measured, for example, with a commercially available turbidimeter, such as NDH-1001DP (produced by Nippon Denshoku Industries Co., Ltd.). The base film may be available as “COSMO SHINE A1517” and “COSMO SHINE A4100”, trade names, produced by Toyobo Co., Ltd.

The base film may be subjected to a releasing treatment, an antistatic treatment and the like for facilitating release.

### Step (III)

The step (III) in the production method according to the first embodiment of the present invention is, as shown in FIG. 1(d), a step of forming a second core layer 5 by laminating a resin film for forming a core layer 20 on the entire surface of the first core layer 3 and the first cladding layer 2.

The resin film for forming a core layer used herein is preferably similar to one used for forming the first core layer from the standpoint of the attainment of stable light transmission characteristics.

The conditions for laminating the resin film for forming a core layer are also preferably similar to the case of forming the first core layer 3.

The surface of the second core layer 5 thus formed has a step between the portion where the first core layer 3 is formed and the intermediate portion, as shown in FIG. 1(d). In the step (III) in the production method of the present invention, from the standpoint of the decrease in optical loss, after laminating the resin film for forming a core layer on the entire surface of the first core layer and the first cladding layer, the step is preferably flattened to form a second core layer having a tapered shape. Examples of the method for flattening include a method of compressing the laminate obtained through the steps (I) to (III) vertically as shown in FIG. 1(e). The method of compressing is not particularly limited, and a plate laminator is preferably used for performing flattening efficiently.

The plate laminator in the present invention designates a laminator that holds a laminated material between a pair of flat plates, and press-adheres the material by pressing the flat plates. As the plate laminator, for example, a vacuum press laminator described in JP-A-11-320682 may be preferably used.

The pressing members 31 are not particularly limited as far as they have a certain hardness, and examples thereof include a metal plate, such as a stainless steel plate, and silicone rubber with high hardness.

The flattening using the plate laminator is preferably performed under reduced pressure from the standpoint of enhancement of the flatness and the adhesiveness. The upper limit of the vacuum degree, which is an index of reduction of pressure, is preferably 10,000 Pa or less, and more preferably 1,000 Pa or less. The lower limit of the vacuum degree is preferably approximately 10 Pa from the standpoint of the productivity (e.g., the time required for vacuuming). The heating temperature thereon is preferably from 40 to 130° C., and the pressing pressure is preferably from 0.1 to 1.0 MPa (from 1 to 10 kgf/cm²).

The flattening of the step on the surface of the second core layer integrates the first core layer 3 and the second core layer 5 to form a core layer 6, and the thickness of the core is large at the end portions and is small at the intermediate portion with a tapered shape having no step between the thick portion and the thin portion, as shown in FIG. 1(f).

The thickness of the core layer is as described above, and the inclination angle of the taper is preferably in a range of from 0.1 to 2°, and more preferably in a range of from 0.1 to 1°, for preventing the optical loss from being increased.

### Step (IV)

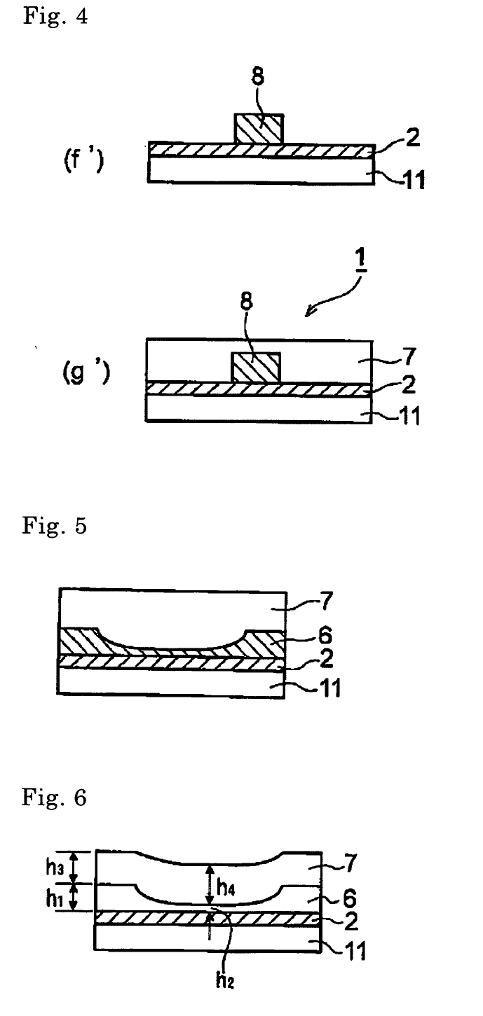

The step (IV) in the production method according to the first embodiment of the present invention is a step of patterning the core layer 6 (i.e., the first core layer and the second core layer). The method of patterning employed may be various methods, and it is preferred that a photosensitive resin is used as the resin for forming a core layer, and the patterning is performed by exposure and development. FIG. 4(f′) is an illustration of the patterned laminate from the direction x in FIG. 1(f).

The core pattern produced in the step (IV) may contain a dummy core, which is not used as a light transmission path, at least in one end portion, along with the core part functioning as a light transmission path.

As a method of exposing, specifically, active light is radiated imagewise through a negative mask pattern. Examples of the light source of the active light include known light sources capable of radiating effectively an ultraviolet ray, such as a carbon arc lamp, a mercury vapor arc lamp, a super-high pressure mercury lamp, a high pressure mercury lamp and a xenon lamp. Ones capable of radiating effectively visible light, such as a photoflood lamp and a sun lamp, may also be used.

After heating depending on necessity after the exposure, the base film of the resin film for forming a core layer is released when the base film remains, and then development was performed by removing the unexposed area by wet development, dry development or the like, thereby producing the core pattern. In the case of wet development, the development is performed with a developer solution corresponding to the composition of the resin film, selected from an organic solvent, an alkaline aqueous solution, an aqueous developer solution and the like, by a known method, such as spraying, immersing under vibration, brushing or scrubbing.

The developer solution is preferably one that is safe and stable and has good operability, such as an organic solvent and an alkaline aqueous solution. Examples of the organic solvent developer solution include 1,1,1-trichloroethane, N-methylpyrrolidone, N,N-dimethylformamide, N,N-dimethylacetamide, cyclohexanone, methyl isobutyl ketone and γ-butyrolactone. The organic solvent may contain water in an amount of from 1 to 20% by mass for preventing ignition.

Examples of the base of the alkaline aqueous solution include an alkali hydroxide, such as hydroxides of lithium, sodium and potassium, an alkali carbonate, such as carbonates and bicarbonates of lithium, sodium, potassium and ammonium, an alkali metal phosphate salt, such as potassium phosphate and sodium phosphate, and an alkali metal pyrophosphate salt, such as sodium pyrophosphate and potassium pyrophosphate. Preferred examples of the alkaline aqueous solution used for the development include a dilute solution of sodium carbonate with a concentration of from 0.1 to 5% by mass, a dilute solution of potassium carbonate with a concentration of from 0.1 to 5% by mass, a dilute solution of sodium hydroxide with a concentration of from 0.1 to 5% by mass and a dilute solution of sodium tetraborate with a concentration of from 0.1 to 5% by mass. The alkaline aqueous solution used for the development preferably has pH in a range of from 9 to 14, and the temperature thereof may be controlled corresponding to the developability of the layer of the photosensitive resin composition. The alkaline aqueous solution may contain a surfactant, a defoaming agent and a small amount of an organic solvent for enhancing the development.

The aqueous developer solution may contain water, an alkali aqueous solution and at least one organic solvent. Examples of the alkali substance herein include those described above and also include borax, sodium metasilicate, tetramethylammonium hydroxide, ethanolamine, ethylenediamine, diethylenetriamine, 2-amino-2-hydroxymethyl-1,3-propanediol, 1,3-diaminopropanol-2 and morpholine. The pH of the developer solution is preferably as small as possible within a range where the development can be sufficiently performed, and the pH is preferably from 8 to 12, and more preferably from 9 to 10. Examples of the organic solvent include triacetone alcohol, acetone, ethyl acetate, an alkoxyethanol having an alkoxy group having from 1 to 4 carbon atoms, ethyl alcohol, isopropyl alcohol, butyl alcohol, diethylene glycol monomethyl ether, diethylene glycol monoethyl ether and diethylene glycol monobutyl ether. These may be used solely or as a combination of two or more kinds thereof. The concentration of the organic solvent is generally preferably from 2 to 90% by mass, and the temperature thereof may be controlled corresponding to the developability. The aqueous developer solution may contain a surfactant, a defoaming agent and the like in a small amount.

Two or more kinds of the developing methods may be employed in combination. Examples of the method of development include a dipping method, a paddling method, a spraying method, such as a high-pressure spraying method, brushing and scrubbing.

The core pattern may be further cured by heating to approximately from 60 to 250° C. or exposing to approximately from 0.1 to 1,000 mJ/cm², as a process after the developing, depending on necessity.

### Step (V)

The step (V) in the production method according to the first embodiment of the present invention is a step of embedding the core pattern by forming a second cladding layer on the core pattern, which is obtained by subjecting the core layer 6 to the exposing and developing method or the like, and the first cladding layer. The step is preferably performed by using a resin film for forming a cladding layer, and it is preferred that the core pattern is embedded, and then the resin of the resin film for forming a cladding layer is cured to form the second cladding layer (i.e., the upper cladding layer) (see FIG. 1(g) and FIG. 4(g′)).

The thickness of the second cladding layer herein is preferably larger than the thickness of the core layer (i.e., the core pattern). The resin for forming the second cladding layer may be cured with light or heat in the similar manner as for forming the first cladding layer.

The resin film for forming the second cladding layer used herein may be similar to the resin film for forming the first cladding layer, and the resin film contains a base film 11 having the resin for forming a cladding layer 12 laminated thereon, as shown in FIG. 2, and may have a structure containing a protective film (separator) 13 laminated thereon depending on necessity. The material for the base film 11 may be similar to the base film of the resin film for forming the first cladding layer. The resin for forming a cladding layer may also be similar to the resin for forming a cladding layer in the resin film for forming the first cladding layer.

In the case where the protective film is provided on the side of the resin film for forming the second cladding layer opposite to the base film (see FIG. 2), the protective film is released off, and then the resin film for forming a cladding layer is cured with light or heat, thereby forming the second cladding layer. The protective film is preferably not subjected to an adhesion treatment, for facilitating release from the resin film for forming a cladding layer, and may be subjected to a release treatment and an antistatic treatment depending on necessity.

In the flexible optical waveguide obtained by the production method according to the first embodiment of the present invention, the resin films for forming the first and the second cladding layers may be released after forming the second cladding layer (i.e., the upper cladding layer).

In the present invention, the base film of the resin film for forming a cladding layer also functions as a supporting member through the production process of the flexible optical waveguide. The base film that has a larger size than a silicon substrate or the like, which has ordinarily been used as a supporting member, may be used, and thus such a production method of a flexible optical waveguide can be provided that can easily produce with a large area and is excellent in productivity.

The base film may be left on one surface of the flexible optical waveguide, but may be released from both the surfaces to provide a symmetrical structure, with which a flexible optical waveguide suffering less warpage can be produced. The thickness of the flexible optical waveguide can be reduced by releasing the base film.

The step of releasing the base film preferably contains a moistening treatment. The moistening treatment can lower the adhesion force between the base film and the cladding layer, thereby facilitating the release of the base film without breakage of the optical waveguide. The moistening treatment is preferably performed, for example, under a high temperature and high humidity condition, a boiling condition, a condition in a pressure cooker, or the like, since the treating time can be decreased by heating.

Flexible Optical Waveguide obtained by Production Method According to First Embodiment of the Present Invention

The flexible optical waveguide obtained by the production method according to the first embodiment of the present invention preferably has, as shown in FIG. 1(g), the core layer 6 (which is formed by laminating and integrating the first core layer 3 and the second core layer 5) of the optical waveguide that has a tapered shape from the end portion toward the intermediate portion. The inclination angle of the taper is preferably in a range of from 0.1 to 2°, and more preferably in a range of from 0.1 to 1°, as described above.

The flexible optical waveguide may have the second cladding layer (i.e., the upper cladding layer) 7 that has a large thickness in the intermediate portion to provide the same thickness over the entire optical waveguide (see FIG. 5), or may have a decreased thickness by itself in the intermediate portion as shown in FIG. 1(g). In this case, the second cladding layer (i.e., the upper cladding layer) 7 also preferably has a tapered shape having a thickness being decreased toward the intermediate portion from the standpoint of enhancement of the bending durability of the optical waveguide. Furthermore, the inclination angle of the second cladding layer (i.e., the upper cladding layer) 7 may be smaller than the inclination angle of the core layer 6 to reduce the thickness change of the tapered portion, thereby enhancing the mechanical strength of the tapered portion. The inclination angle of the second cladding layer (i.e., the upper cladding layer) 7 is preferably in a range of from 0.05 to 1′ in this point of view. The inclination angle of the second cladding layer (i.e., the upper cladding layer) 7 can be controlled by the thickness of the film for forming the upper cladding and the pressure and temperature upon lamination.

By the production method according to the first embodiment of the present invention, as shown in FIG. 6, such an optical waveguide may be produced that the thickness h₂ of the core layer 6 in the intermediate portion is smaller than the thickness h₁ of the core layer 6 in the end portion, and the thickness h₄ of the second cladding layer (i.e., the upper cladding layer) 7 in the intermediate portion is larger than the thickness h₃ of the second cladding layer (i.e., the upper cladding layer) 7 in the end portion, thereby providing a flexible optical waveguide that has favorable flexibility in the bent portion and high light confinement capability with the enhanced mechanical strength of the tapered portion.

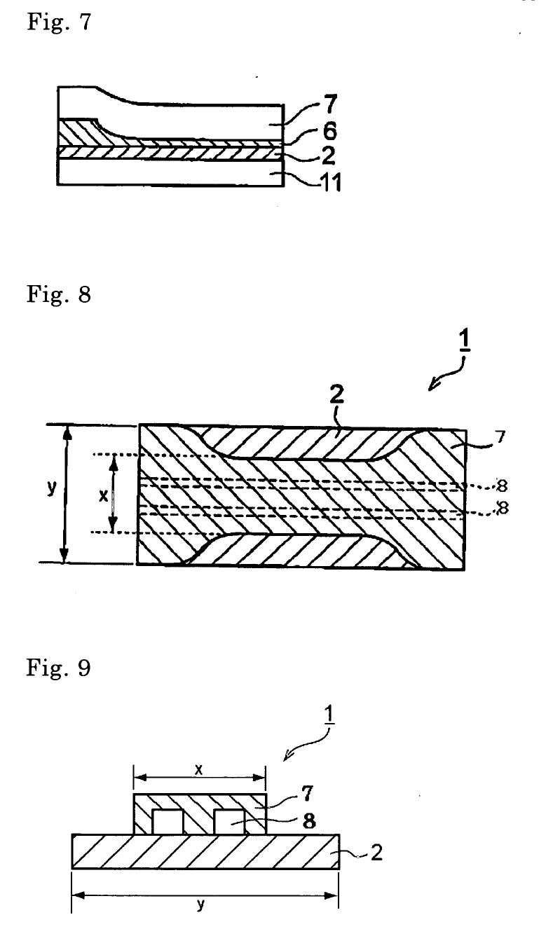

By the production method according to the first embodiment of the present invention, as shown in FIG. 7, such an optical waveguide may be produced that the core layer has a large thickness only in one of the end portion. By using the side of the optical waveguide having the larger thickness of the core layer as the light incident side, the positional deviation with respect to a light emission device, such as a surface emission laser (VCSEL), can be prevented, thereby providing a high optical coupling efficiency. By using the side of the core layer having the smaller thickness as the light emission side, a high transmission speed to a light receiving device, such as a photodiode, can be obtained. Furthermore, excellent bending durability is obtained owing to the small total thickness of the optical waveguide in the intermediate portion.

The flexible optical waveguide obtained by the production method according to the first embodiment of the present invention has, as apparent from the description for the step (V), such a structure that the core pattern is surrounded by the upper cladding layer and the lower cladding layer, and thus a side cladding is provided in addition to the upper and lower cladding layers.

As shown in FIG. 8, furthermore, the width of the upper cladding layer 7 is preferably smaller than the width of the lower cladding layer in the intermediate portion (FIG. 8 is a phantom view from the side of the upper cladding layer). The upper cladding layer having a smaller width further enhances the bending durability. The bending durability in the intermediate portion can be enhanced by decreasing the width of the upper cladding layer in the intermediate portion, but for exerting the function of the cladding layer sufficiently, such a width is required that the core layer is completely embedded in the upper cladding layer, thereby maintaining the favorable light transmission characteristics. Taking these factors into consideration, the width x of the upper cladding layer is preferably approximately from 20 to 60%, and more preferably from 20 to 50%, of the width y of the lower cladding layer.

As a method of making the width of the upper cladding layer smaller than the width of the lower cladding layer in the intermediate portion, such a method may be employed that the resin film for forming the second cladding layer is exposed and developed, thereby forming the second cladding layer (i.e., the upper cladding layer) 7 having a smaller width than the width of the first cladding layer (i.e., the lower cladding layer) 2 in the intermediate portion while maintaining the core pattern embedded. Such a method may also be employed that a resin film for forming the upper cladding layer is produced in advance with such a shape that the width of the upper cladding layer is made smaller than the width of the lower cladding layer in the intermediate portion, and then the resin film is laminated on the core pattern, thereby embedding the core pattern.

### Flexible Optical Waveguide According to Second Embodiment of the Present Invention

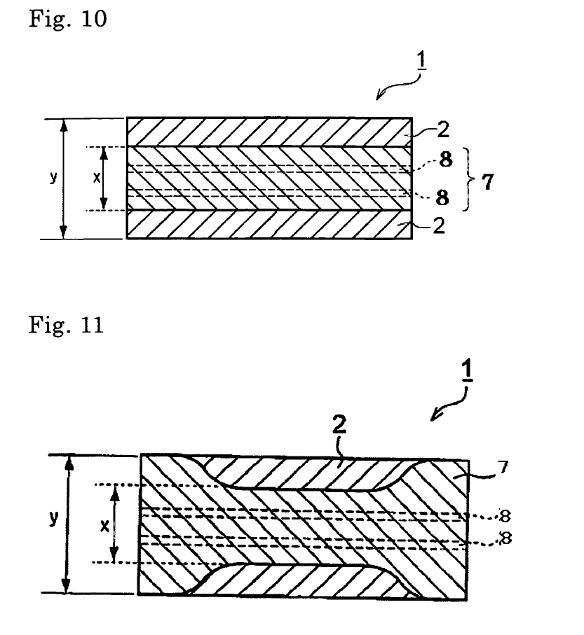

An optical waveguide according to the second embodiment of the present invention contains a lower cladding layer, a core part and an upper cladding layer. The upper cladding layer has a width that is smaller than a width of the lower cladding layer at least in a bent portion, and is equal to or smaller than a width of the lower cladding layer in an end portion, and the lower cladding layer has a width in a bent portion that is equal to or smaller than a width thereof in an end portion. The term “bent portion” herein means a portion that is bent with a hinge or the like when the flexible optical waveguide is installed in an electronic device or the like. The descriptions will be made with reference to FIGS. 9 to 11 below.

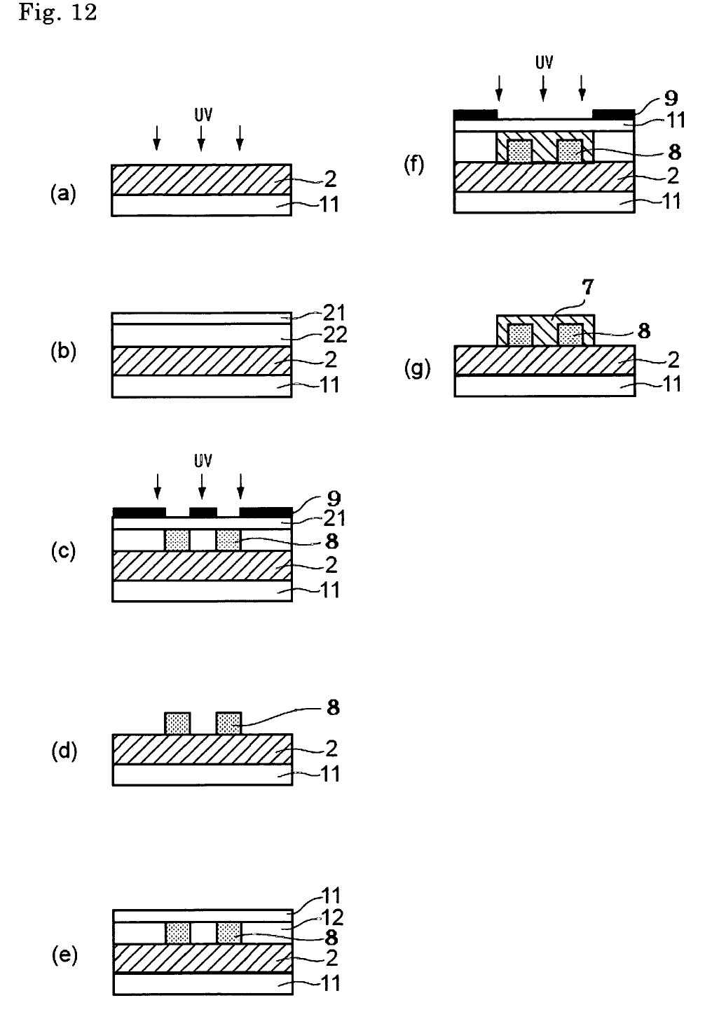

FIGS. 9 to 11 are schematic illustrations showing an optical waveguide according to the second embodiment of the present invention, in which FIG. 9 is a schematic illustration viewed in the waveguide direction, and FIGS. 10 and 11 are phantom views viewed from the side of the upper cladding layer. The optical waveguide 1 according to the second embodiment of the present invention contains a lower cladding layer 2, a core part 8 and an upper cladding layer 7, and the width x of the upper cladding layer 7 is smaller than the width y of the lower cladding layer 2.

It is sufficient that the portion where the width of the upper cladding layer 7 is small may be present at least in the bent portion, and in the end portion, it may be the same as or smaller than the width of the lower cladding layer. More specifically, the width of the upper cladding layer may be smaller over one end portion to the other end portion as shown in FIG. 10, or the width of the upper cladding layer may be smaller only in the bent portion except for both the end portions. The bending durability in the bent portion can be enhanced by decreasing the width of the upper cladding layer in the bent portion, but for exerting the function of the cladding layer sufficiently, such a width is required that the core layer 8 is completely embedded in the upper cladding layer 7, thereby maintaining the favorable light transmission characteristics. Taking these factors into consideration, the width x of the upper cladding layer 7 in the bent portion is preferably approximately from 20 to 60%, and more preferably from 20 to 50%, of the width y of the lower cladding layer 2.

In the examples shown in FIGS. 10 and 11, the width of the lower cladding layer is the same between the bend portion and the end portion, but the width of the lower cladding layer in the bent portion is preferably smaller than the width thereof in the end portion from the standpoint of the bending durability. In the embodiment where the lower cladding layer has a smaller width in the bent portion, the width y of the lower cladding layer 2 means the width thereof in the end portion.

In the present invention, the width of the upper cladding layer is made smaller at least in the bent portion, and on the other hand, in the end portion, the lower cladding layer has a width that is the same as an ordinary one. The object therefor will be described.

In an optical waveguide or an optoelectronic circuit board containing the same laminated with FPC (flexible printed circuit), the end portion thereof necessarily has a certain width for connecting to a connector or a optical device. For ensuring the width, such a structure is necessarily provided that the lower cladding layer is left remaining as shown in FIG. 10, or the upper cladding layer having a width equivalent to the lower cladding layer is left remaining only in the end portion as shown in FIG. 11. In the case where the end portion is connected to a connector, in particular, the structure shown in FIG. 11 is preferably employed to provide the optical waveguide that has a constant thickness in the end portion.

The flexible optical waveguide according to the second embodiment of the present invention particularly exerts excellent effect in the case where the flexible optical waveguide is applied to an optoelectronic circuit board. Examples of the method for producing the optoelectronic circuit board include (1) a method of producing the optical waveguide and FPC separately, and then laminating them with an adhesive or the like, (2) a method of laminating the optical waveguide by building up the lower cladding layer, the core layer and the upper cladding layer in this order on FPC, and (3) a method of building up the optical waveguide on CCL (copper cladding laminate), and processing the CCL to a circuit.

For laminating plural optical waveguide arrays on FPC at one time in the method (1), the work assembly is necessarily continuous. In the methods (2) and (3), for laminating the core layer, the lower cladding layer thereunder is demanded to be flat. In view of this point, high productivity may be obtained by forming the lower cladding layer according to an ordinary method and decreasing only the width of the upper cladding layer, in the case where the optoelectronic circuit board is produced with a work assembly having optical waveguides arranged in an array form.

In the optical waveguide according to the second embodiment of the present invention, the thickness of the lower cladding layer is preferably in a range of from 5 to 500 μm after drying. When the thickness is 5 μm or more, the thickness that is required for confinement of light is ensured, and when it is 500 μm or less, the film thickness can be easily controlled uniformly. The thickness of the cladding layer is more preferably in a range of from 10 to 100 μm in this point of view.

The thickness of the core layer is generally controlled to from 10 to 100 μm. When the thickness of the core layer is 10 μm or more, such an advantage is obtained that the positioning tolerance upon coupling with a light receiving device or an optical fiber after forming the optical waveguide can be enhanced, and when it is 100 μm or less, such an advantage is obtained that the coupling efficiency upon coupling with alight receiving device or an optical fiber after forming the optical waveguide can be enhanced. The thickness of the core layer is more preferably in a range of from 30 to 70 μm in this point of view.

The thickness of the upper cladding layer and the thickness of the lower cladding layer may be the same as or different from each other, and are preferably larger than the height of the core part, for embedding the core pattern.

### Production Method of Flexible Optical Waveguide According to Second Embodiment of the Present Invention

The production method of an optical waveguide according to the second embodiment of the present invention will be described in detail for the respective steps with reference to FIG. 12. In the production method according to the second embodiment of the present invention, upon forming a cladding layer and a core layer, the layers may be laminated by coating a resin for forming the cladding layer or the core layer by a spin coating method or the like, but it is preferred to use a resin film for forming a cladding layer and a resin film for forming a core layer. The use of the resin films facilitates control of the film thickness and enhances the handleability. The step diagram shown in FIG. 12 describes the case using the resin films.

The resin for forming a cladding layer of the resin film for forming the lower cladding layer is cured to form the lower cladding layer (see the step (i), FIG. 12(a)).

The resin film for forming a cladding layer 10 used herein contains a base film 11 having a resin for forming a cladding layer 12 coated thereon, as shown in FIG. 2, and may have a structure containing a protective film (separator) 13 laminated thereon depending on necessity.

The protective film and the base film 11 may be similar to the protective film and the base film in the first embodiment of the present invention.

In the step (i), in the case where the protective film 13 is provided on the side of the resin film for forming a cladding layer opposite to the base film (see FIG. 2), the protective film is released off, and then the resin film for forming a cladding layer is cured with light (such as ultraviolet ray (UV)) or heat, thereby forming a lower cladding layer 2.

The base film and the protective film of the resin film for forming a cladding layer may be similar to those in the first embodiment of the present invention.

The resin for forming a cladding layer used in the second embodiment of the present invention is not particularly limited as far as it is a resin composition that has a lower refractive index than a core layer and is capable of being cured with light or heat, and a thermosetting resin composition and a photosensitive resin composition may be used.

It is more preferred that the resin for forming a cladding layer is constituted by a resin composition that contains (A) a base polymer, (B) a photo- or heat-polymerizable compound and (C) a photo- or heat-polymerization initiator, and it is further preferred that the resin for forming a cladding layer is constituted by a resin composition that contains (A) a base polymer, (B) a photopolymerizable compound and (C) a photopolymerization initiator.

The base polymer (A), the photo- or heat-polymerizable compound (B) and the photo- or heat-polymerization initiator (C) may be similar to the components (A) to (C) described for the first embodiment of the present invention.

The production method of the resin film for forming a cladding layer may be the same as the method in the first embodiment of the present invention.

The thickness of the resin part of the resin film for forming a cladding layer is controlled to the thickness of the upper cladding layer or the lower cladding layer.

Subsequently, a resin film for forming a core layer is laminated on the lower cladding layer 2, thereby forming a core layer (see the step (ii), FIG. 12(b)).

The resin film for forming a core layer used herein may be similar to that in the first embodiment of the present invention.

The production method of the resin film for forming a core layer may also be the same as the method in the first embodiment of the present invention.

Upon laminating the resin film for forming a core layer 20, the resin film for forming a core layer is preferably laminated under reduced pressure from the standpoint of the adhesiveness and the followability. The heating temperature thereon is preferably from 50 to 130° C., and the pressing pressure is preferably approximately from 0.1 to 1.0 MPa (from 1 to 10 kgf/cm²). These conditions are not particularly limited.

The film is preferably laminated with a roll laminator from the standpoint of preventing bubbles from being entrained between the lower cladding layer and the core layer.

The core layer is then patterned to form a core pattern 8 of the optical waveguide (see the step (iii), FIGS. 12(c) and 12(d)). The method of patterning the core layer to form a core pattern of the optical waveguide may be various methods, and from the standpoint of the handiness it is preferred that a photosensitive resin is used as the resin for forming a core layer, and the patterning is performed by the exposure and development method.

The core pattern produced in the step (iii) may contain a dummy core, which is not used as a light transmission path, at least in one end portion, along with the core part functioning as a light transmission path.

The exposure and development method may be the same as the method in the first embodiment of the present invention, and the light source of the active light, the developer solution and the like may also be the same as those in the first embodiment of the present invention.

A resin film for forming the upper cladding layer is then laminated on the core pattern 8, which is obtained by subjecting the core layer to the exposure and development, thereby embedding the core pattern (see the step (iv), FIG. 12(e)).

The resin film for forming the upper cladding layer used herein may be similar to the resin film for forming the lower cladding layer, and the resin film contains a base film 11 having the resin for forming a cladding layer 12 laminated thereon, as shown in FIG. 2, and may have a structure containing a protective film (separator) 13 laminated thereon depending on necessity. The material for the base film 11 may be similar to the base film of the resin film for forming the lower cladding layer. The resin for forming a cladding layer may also be similar to the resin for forming a cladding layer in the resin film for forming the lower cladding layer.

In the case where the protective film is provided on the side of the resin film for forming the upper cladding layer opposite to the base film (see FIG. 2), the protective film is released off, and then the resin film for forming a cladding layer is cured with light or heat, thereby forming the upper cladding layer. The protective film is preferably not subjected to an adhesion treatment, for facilitating release from the resin film for forming a cladding layer, and may be subjected to a release treatment and an antistatic treatment depending on necessity.

The thickness of the resin part of the resin film for forming the upper cladding layer is preferably larger than the height of the core part, for embedding the core pattern.

The resin film for forming the upper cladding layer is then exposed and developed, thereby forming the upper cladding layer 7 having a width that is smaller than the lower cladding layer 2 at least in the bent portion, while maintaining the core pattern 8 embedded (see the step (v), FIGS. 12(f) and 12(g)).

The exposure and development method may be the same as the method described for the step (iii), and the light source of the active light, the developer solution and the like may also be the same as those in the step (iii).

In the production method according to the second embodiment of the present invention, as described above, it is important that the core part 3 is completely embedded in the upper cladding layer 7, for exerting the sufficient function of the cladding layer, and it is necessary to maintain the embedded state of the core pattern after the exposure and development.

The upper cladding layer is cured through the exposing process, but is preferably cured completely by radiating light again or by heating after the development.

In the production method according to the second embodiment of the present invention, a portion having a smaller width can be favorably formed easily in the upper cladding layer by the exposure and development in the step (v). In the production method according to the second embodiment of the present invention, furthermore, the shape of the upper cladding layer can be easily controlled by changing the shape of the mask pattern 9 in the step (v), and thereby the upper cladding layers having various shapes as shown in FIGS. 10 and 11 can be easily provided.

In the production of an optical waveguide according to the second embodiment of the present invention, such a method may be employed instead of the steps (iv) and (v) that the resin film for forming the upper cladding layer that has a shape providing the upper cladding layer having a smaller width than the lower cladding layer in the bent portion is produced in advance, and then the resin film is laminated on the core pattern to embed the core pattern. In the case employing the method, the resin film for forming the upper cladding layer is laminated and then cured with light (such as ultraviolet ray (UV)) or heat, thereby forming the upper cladding layer, and thus the optical waveguide of the present invention is provided.

In the second embodiment of the present invention, the base film of the resin film for forming a cladding layer also functions as a supporting member through the production process of the optical waveguide. The base film that has a larger size than a silicon substrate or the like, which has ordinarily been used as a supporting member, may be used, and thus the production method easily produces with a large area and is excellent in productivity.

The step of releasing the base film preferably contains a moistening treatment. The moistening treatment can lower the adhesion force between the base film and the cladding layer, thereby facilitating the release of the base film without breakage of the optical waveguide. The moistening treatment is preferably performed, for example, under a high temperature and high humidity condition, a boiling condition, a condition in a pressure cooker, or the like, since the treating time can be decreased by heating.

The optical waveguide according to the second embodiment of the present invention has, as apparent from the description for the steps (iv) and (v), such a structure that the core pattern is surrounded by the upper cladding layer and the lower cladding layer, and thus a side cladding is provided in addition to the upper and lower cladding layers.

### Flexible Electric Circuit Board

A flexible optical waveguide produced by the production method according to the first embodiment of the present invention or a flexible optical waveguide produced by the production method according to the second embodiment of the present invention may be formed in to a composite with a flexible electric circuit board (a flexible printed circuit board, which is hereinafter referred to as FPC), thereby producing a flexible type optoelectronic circuit board. The optoelectronic circuit board with FPC has a thickness that is increased by the FPC, and therefore, the small thickness of the optical waveguide in the bent portion is significantly important for enhancement of the bending property.

Examples of the method of lamination include a method of laminating the optical waveguide and the electric circuit board having been separately produced, with an adhesive or the like, and also include a method of building up the optical waveguide on FPC, and a method of forming the optical waveguide on polyimide with a copper foil by building up, and then a copper circuit is formed by patterning, thereby producing FPC.

### Example

The present invention will be described with reference to examples below, but the present invention is not limited to the examples.

### 1. Tensile Elastic Modulus and Tensile Strength

A specimen having a width of 10 mm and a length of 70 mm was obtained from a film to be measured and measured with a tensile tester (RTM-100, produced by Orientec Co., Ltd.) under the following condition according to JIS K7127.

### Condition:

Distance of chuck: 50 mm

Temperature: 25° C.

Tensile speed: 50 mm/min

The tensile elastic modulus was calculated with the initial linear portion of the tensile stress-distortion curve according to the following expression. The maximum strength at breakage in the tensile stress-distortion curve was designated as the tensile strength.

tensile elastic modulus (MPa)=(difference of stress between two points on straight line (N))/(original average cross sectional area of optical waveguide film (mm²))/difference of distortion between the same two points)

### 2. Bending Durability Test

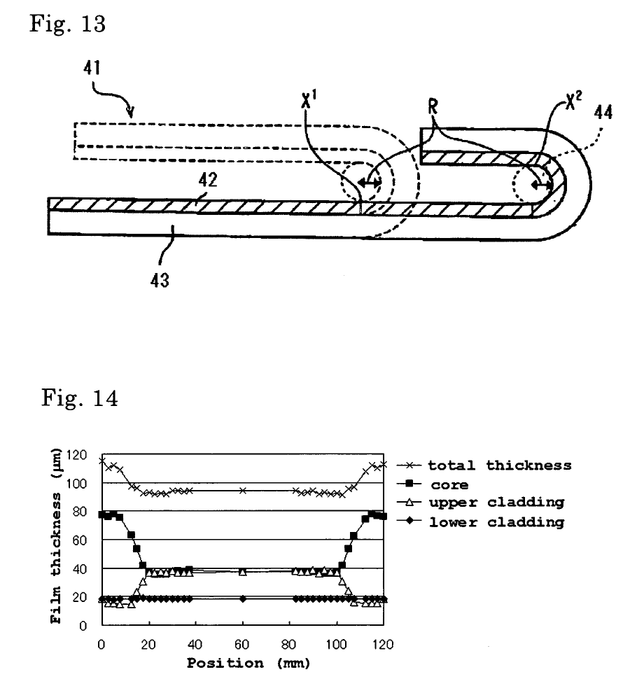

The optoelectronic circuit boards produced in Examples and Comparative Examples were subjected to a bending durability test by using a slide type bending durability tester (produced by Daisho Denshi Co., Ltd.) shown in FIG. 13. The test was performed by disposing the optoelectronic circuit board 41 produced in Example or Comparative Example with the flexible optical waveguide directed inward with respect to the bending axis 44. The test was performed under such conditions that the bending radius (R) was 1.5 mm, the sliding speed was 80 mm/sec, and the distance between X¹ and X² was 20 mm. On evaluation, the presence of breakage was observed every 10,000 times to measure the maximum number of times without breakage. The bending axis 44 is not actually present but is a virtual axis upon bending and sliding the optoelectronic circuit board.

### Example 1

### (1) Production of Resin Film for forming Cladding Layer

48 parts by mass of a phenoxy resin (Phenotohto YP-70, a trade name, produced by Tohto Kasei Co., Ltd.) as the binder polymer (A), 49.6 parts by mass of an alicyclic diepoxy carboxylate (KRM-2110, a trade name, produced by ADEKA Corporation, molecular weight: 252) as the photo- or heat-polymerizable compound (B), 2 parts by mass of triphenyl sulfonium hexafluoroantimonate salt (SP-170, a trade name, produced by ADEKA Corporation) as the photo- or heat-polymerization initiator (C), 0.4 part by mass of SP-100 (a trade name, produced by ADEKA Corporation) as a sensitizer, and 40 parts by mass of propylene glycol monomethyl ether acetate as an organic solvent were weighed in a wide-mouth resin bottle, and stirred with a mechanical stirrer, a shaft and a propeller under condition of a temperature of 25° C. and a rotation number of 400 rpm for 6 hours, thereby providing a resin varnish for forming a cladding layer A. Thereafter, the resin varnish was filtered under pressure with a Polyflon filter with a pore size of 2 μm (PF020, a trade name, produced by Advantec Toyo Co., Ltd.) under condition of a temperature of 25° C. and a pressure of 0.4 MPa, and then defoamed under reduced pressure with a vacuum pump and a bell jar at a depressurization degree of 50 mmHg for 15 minutes.

The resin varnish for forming a cladding layer A thus obtained was coated on a corona-treated surface of an aramid film (Mictron, a trade name, produced by Toray Industries, Inc., thickness: 12 μm) with a coating machine (Multicoater TM-MC, produced by Hirano Tecseed Co., Ltd.), and dried at 80° C. for 10 minutes and then at 100° C. for 10 minutes, and subsequently a releasable PET film (Purex A31, a trade name, produced by Teijin DuPont Films Japan Ltd., thickness: 25 μm) as a protective film was adhered thereto with the releasable surface directed to the resin, thereby providing a resin film for forming a cladding layer. The thickness of the resin layer herein can be arbitrarily controlled by changing the gap of the coating machine. In this example, the gap was controlled to provide a thickness of the film for a lower cladding layer of 20 μm, and a thickness of the film for an upper cladding layer of 66 μm.

### (2) Production of Resin Film for Forming Core Layer

A resin varnish for forming a core layer B was prepared in the same manner and the same conditions as in the aforementioned production example except for using 26 parts by mass of a phenoxy resin (Phenotohto YP-70, a trade name, produced by Tohto Kasei Co., Ltd.) as the binder polymer (A), parts by mass of 9,9-bis[4-(2-acryloyloxyethoxy)phenyl]fluorene (A-BPEF, a trade name, produced by Shin-Nakamura Chemical Co., Ltd.) and 36 parts by mass of bisphenol A type epoxy acrylate (EA-1020, a trade name, produced by Shin-Nakamura Chemical Co., Ltd.) as the photo- or heat-polymerizable compound (B), 1 part by mass of bis(2,4,6-trimethylbenzoyl)phenylphosphine oxide (Irgacure 819, a trade name, produced by Ciba Japan Co., Ltd.) and 1 part by mass of 1-[4-(2-hydroxyethoxy)-phenyl]-2-hydroxy-2-methyl-1-propan-1-one (Irgacure 2959, a trade name, produced by Ciba Japan Co., Ltd.) as the photo- or heat-polymerization initiator (C), and 40 parts by mass of propylene glycol monomethyl ether acetate as an organic solvent. Thereafter, the varnish was filtered under pressure and then defoamed under reduced pressure in the same manner and the same conditions as in the aforementioned production example.

The resin varnish for forming a core layer B thus obtained was coated on a non-treated surface of a PET film (Cosmoshine A1517, a trade name, produced by Toyobo Co., Ltd., thickness: 16 μm) and dried in the same manner as in the aforementioned production example, and subsequently a releasable PET film (Purex A31, a trade name, produced by Teij in DuPont Films Japan Ltd., thickness: 25 μm) as a protective film was adhered thereto with the releasable surface directed to the resin, thereby providing a resin film for forming a core layer. In this example, the gap of the coating machine was controlled to provide a film thickness of 40 μm.

### (3) Production of Flexible Optical Waveguide

The releasable PET film (Purex A31) as the protective film of the resin film for forming the lower cladding layer obtained above was released therefrom, and the resin film was irradiated with an ultraviolet ray (wavelength: 365 nm) at 1 J/cm² from the side of the resin (i.e., the opposite side to the base film) from an ultraviolet ray exposing machine (EXM-1172, produced by ORC MANUFACTURING Co., Ltd.) and then subjected to a heat treatment at 80° C. for 10 minutes, thereby forming the first cladding layer (i.e., the lower cladding layer) (step (I)). The lower cladding layer had a thickness of approximately 20 μm.

Subsequently, a PET film (Cosmoshine A31, a trade name, produced by Toyobo Co., Ltd., thickness: 25 μm) as a masking film was disposed on the intermediate portion (90 mm) of the lower cladding layer, and the resin film for forming a core layer was laminated on the lower cladding layer remaining in the end portions (with a length of 20 mm from the edge) and the masking film with a roll laminator (HLM-1500, produced by Hitachi Chemical Technoplant Co., Ltd.) under condition of a pressure of 0.5 MPa, a temperature of 50° C. and a lamination speed of 0.2 m/min.

The resin for forming a core layer on the masking film was removed along with the masking film, thereby providing the first core layer on both the end portions of the lower cladding layer (step (II)). The first core layer had a thickness of approximately 40 μm.

The resin film for forming a core layer was laminated on the entire surface including the lower cladding layer and the first core layer with a roll laminator (HLM-1500, produced by Hitachi Chemical Technoplant Co., Ltd.) under condition of a pressure of 0.5 MPa, a temperature of 50° C. and a lamination speed of 0.2 m/min, thereby forming the second core layer (step (III)). The core layer in the end portion had a thickness of approximately 80 μm, and the core layer in the intermediate portion had a thickness of approximately 40 μm.

The resulting assembly was vacuumed at 500 Pa or less for 7 seconds and then flattened under condition of a pressure of 0.4 MPa, a temperature of 60° C. and a pressing time of 30 seconds, with a vacuum pressure laminator (MVLP-500, produced by Meiki Co., Ltd.) as a plate laminator (step (III)). The pressing member used was a stainless steel plate.

After flattening, the core layer had a tapered shape from the end portion toward the intermediate portion, and the inclination angle thereof was 0.15°.

The assembly was irradiated with an ultraviolet ray (wavelength: 365 nm) at 0.6 J/cm² with the aforementioned ultraviolet ray exposing machine through a negative photomask with a width of 50 μm, then subjected to post-exposure heating at 80° C. for 5 minutes. Thereafter, the PET film as the supporting film was released off, and the core pattern was developed with a developer solution (propylene glycol monomethyl ether acetate/N,N-dimethylacetamide=8/2 by mass). Subsequently, the assembly was rinsed with a rinsing liquid (isopropanol) and then dried at 100° C. for 10 minutes, thereby providing the core pattern (step (IV)).

The resin film for forming a cladding layer was then laminated thereto as the upper cladding layer under the same lamination condition as above (step (V)). The assembly was further irradiated with an ultraviolet ray (wavelength: 365 nm) from both the surfaces thereof at 25 J/cm² in total, and then subjected to a heat treatment at 160° C. for 1 hour, thereby forming the upper cladding layer (step (V)), and thus a flexible optical waveguide having the base film disposed outward was produced. The flexible optical waveguide was treated under a high temperature and high humidity condition of 85° C. and 85% for 24 hours for releasing the aramid film, and thus the flexible optical waveguide, from which the base film had been removed, was produced. The results of measurement of the film thickness of the flexible optical waveguide thus produced are shown in FIG. 14.

The core layer and the cladding layer were measured for refractive index with a prism coupler (Model 2010, produced by Metricon Corporation), and the refractive index was 1.584 for the core layer and 1.550 for the cladding layer at a wavelength of 830 nm. The flexible optical waveguide thus produced (FIG. 14) was measured for insertion loss with a surface emission laser of 850 nm (FLS-300-01-VCL, produced by EXFO, Inc.) as a light source, Q82214, produced by Advantest Corporation, as a light receiving sensor, a GI-50/125 multimode fiber (NA=0.20) as an incoming fiber, and SI-114/125 multimode fiber (NA=0.22) as an outgoing fiber, and the insertion loss was 1.0 dB. The flexible optical waveguide having a core that had a constant thickness of 80 μm provided an insertion loss of 0.8 dB, as shown in Comparative Example 1 described later, and it was thus confirmed that the increase of loss due to the tapered structure introduced was as sufficiently small as 0.2 dB.

The resulting flexible optical waveguide was measured for tensile elastic modulus and tensile strength in the aforementioned manners, and the flexible optical waveguide had a tensile elastic modulus of 2,000 MPa and a tensile strength of 70 MPa.

### (4) Production of Optoelectronic Circuit Board

### (4-1) Production of Sheet Adhesive

100 parts by mass of HTR-860P-3 (a trade name, produced by Teikoku Chemical Industries Co., Ltd., glycidyl group-containing acrylic rubber, molecular weight: 1,000,000, Tg: −7° C.), 5.4 parts by mass of YDCN-703 (a trade name, produced by Tohto Kasei Co., Ltd., o-cresol novolac type epoxy resin, epoxy equivalent: 210), 16.2 parts by mass of YDCN-8170C (a trade name, produced by Tohto Kasei Co., Ltd., bisphenol F type epoxy resin, epoxy equivalent: 157), 15.3 parts by mass of Plyophen LF2882 (a trade name, produced by DIC Corporation, bisphenol A novolac resin), 0.1 part by mass of NUCA-189 (a trade name, produced by Nippon Unicar Co., Ltd., y-mercaptopropyltrimethoxysilane), 0.3 part by mass of NUCA-1160 (a trade name, produced by Nippon Unicar Co., Ltd., γ-ureidopropyltriethoxysilane), 30 parts by mass of A-DPH (a trade name, produced by Shin-Nakamura Chemical Co., Ltd., dipentaerythritol hexaacrylate), 1.5 parts by mass of Irgacure 369 (a trade name, produced by Ciba Japan Co., Ltd., 2-benzyl-2-dimethylamino-1-(4-morpholinophenyl)-butanon-1-one, 1-369), and cyclohexanone were mixed under stirring, and defoamed under vacuum, thereby providing a pressure-sensitive adhesive varnish. The pressure-sensitive adhesive varnish was coated on a protective film formed of polyethylene terephthalate having a thickness of 75 μm with a surface releasing treatment (Teijin Tetrone Film A-31, produced by Teijin, Ltd.), and dried under heating at 80° C. for 30 minutes, thereby providing a pressure-sensitive adhesive sheet containing the pressure-sensitive adhesive layer and the protective film. A light transmissible supporting base material having a thickness of 80 μm (FHF-100, produced by Thermo Co., Ltd., a three-layer film of low density polyethylene terephthalate/vinyl acetate/low density polyethylene terephthalate) was laminated on the side of the pressure-sensitive adhesive layer of the pressure-sensitive adhesive sheet, thereby producing a sheet adhesive containing the protective film (polyethylene terephthalate with a surface releasing treatment), the pressure sensitive adhesive layer and the light transmissible supporting base material. The pressure-sensitive adhesive layer had a thickness of 10 μm.

### (4-2) Production of Optoelectronic Circuit Board

The flexible optical waveguide produced above was laminated on the side of the pressure-sensitive adhesive layer of the sheet adhesive, from which the protective film had been released off, with a roll laminator (HLM-1500, produced by Hitachi Chemical Technoplant Co., Ltd.) under condition of a pressure of 0.4 MPa, a temperature of 50° C. and a lamination speed of 0.2 m/min. An ultraviolet ray (365 nm) was radiated on the side of the supporting base material of the sheet adhesive at 250 mJ/cm², thereby releasing the supporting base material off through decrease of the adhesion force at the interface between the pressure-sensitive adhesive layer and the supporting base material. On the surface, from which the supporting base material had been released off, FPC having an electric circuit pattern (base material: Kapton EN, 12.5 μm, thickness of copper circuit: 5 μm) was disposed at the prescribed position by positioning with a mask aligner of an ultraviolet ray exposure (MAP-1200-L, produced by Dainippon Screen Mfg. Co., Ltd.), and after vacuuming at 500 Pa or less for 30 seconds with the aforementioned vacuum pressure laminator, press-adhered under condition of a pressure of 0.4 MPa, a temperature of 100° C. and a pressing time of 30 seconds, followed by heating at 180° C. for 1 hour in a clean oven, thereby adhering the flexible optical waveguide and the FPC, and thus an optoelectronic circuit board was provided.

The resulting optoelectronic circuit board was subjected to the repeated sliding test (bending durability test) in the aforementioned manner, and as a result, suffered no breakage of the optical waveguide after 100,000 times, which meant good bending durability (sliding durability) (see Table 1).

### Comparative Example 1

A flexible optical waveguide having a core that had a constant thickness of 80 μm was produced in the same manner as in Example 1 except that the two-step lamination of the core was not performed, but a core film having a thickness of 80 μm was used. An optoelectronic circuit board was produced in the same manner as in Example 1. In this case, the insertion loss was 0.8 dB, but in the repeated sliding test of the optoelectronic circuit board, the optical waveguide was broken after 5,000 times, thereby failing to provide sufficient bending durability (sliding durability) (see Table 1).

### Example 2

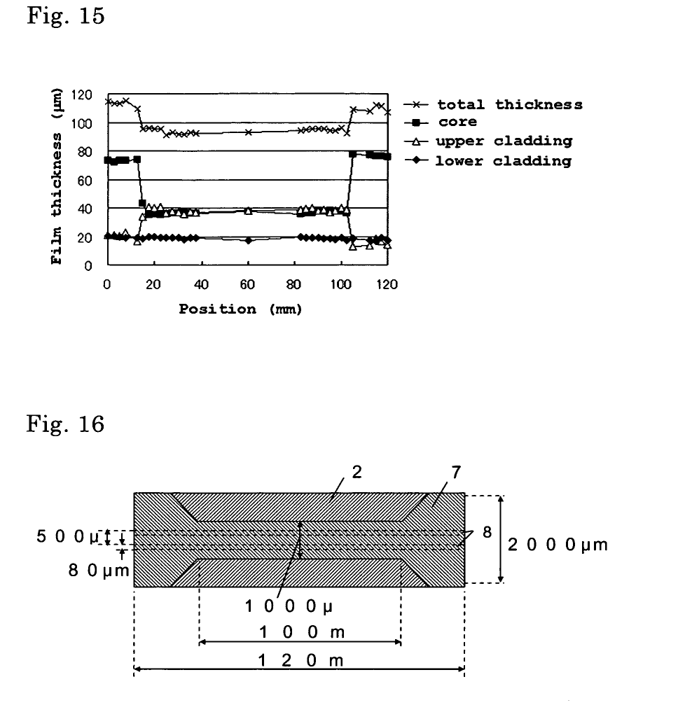

A flexible optical waveguide and an optoelectronic circuit board were produced in the same manner as in Example 1 except that the flattening with a plate vacuum pressure laminator was not performed. The results of measurement of the film thickness of the flexible optical waveguide thus produced are shown in FIG. 15. In the repeated sliding test of the optoelectronic circuit board, no breakage of the optical waveguide occurred after 100,000 times, which meant good bending durability (sliding durability). The insertion loss was 2.2 dB, which meant increase of the insertion loss by 1.2 dB as compared to the case where the flattening was performed, and it was thus confirmed that the flattening was preferably performed for the purpose where high optical characteristics were demanded (see Table 1).

### [Table 1]

TABLE 1

| | Film thickness (μm) | | | | | Repeated | |
|---|---|---|---|---|---|---|---|
| | End portion | | Intermediate portion | | Insertion loss | sliding test | |
| | Core | Total thickness | Core | Total thickness | (dB) | (times) | Remarks |
| Example 1 | 77 | 115 | 38 | 94 | 1.0 | >100,000 | flattened |
| Comparative | 80 | 115 | 80 | 115 | 0.8 | <5,000 | constant core |
| Example 1 | | | | | | | thickness |
| Example 2 | 77 | 115 | 38 | 93 | 2.2 | >100,000 | not flattened |

### Example 3

### (1) Production of Resin Film for Forming Cladding Layer

A resin film for forming a cladding layer was produced in the same manner as in Example 1 except that the thickness after curing of the resin layer of the resin film for forming a cladding layer was controlled to 20 μm for both the lower cladding layer and the upper cladding layer.

### (2) Production of Resin Film for Forming Core Layer

A resin film for forming a core layer was produced in the same manner as in Example 1 except that the thickness after curing of the resin layer of the resin film for forming a core layer was controlled to 50 μm.

### (3) Production of Flexible Optical Waveguide

The releasable PET film (Purex A31) as the protective film of the resin film for forming the lower cladding layer obtained above was released therefrom, and the resin film was irradiated with an ultraviolet ray (wavelength: 365 nm) at 1 J/cm² from the side of the resin (i.e., the opposite side to the base film) from an ultraviolet ray exposing machine (EXM-1172, produced by ORC MANUFACTURING Co., Ltd.) and then subjected to a heat treatment at 80° C. for 10 minutes, thereby forming the lower cladding layer (step (i)). The lower cladding layer had a thickness of approximately 20 μm.

Subsequently, the resin film for forming a core layer was laminated on the lower cladding layer with a roll laminator (HLM-1500, produced by Hitachi Chemical Technoplant Co., Ltd.) under condition of a pressure of 0.5 MPa, a temperature of 50° C. and a lamination speed of 0.2 m/min (step (ii)). The core layer had a thickness of approximately 70 μM.

A negative photomask providing a core width of 80 μm as shown in FIG. 16 is disposed, through which the assembly was irradiated with an ultraviolet ray (wavelength: 365 nm) from the aforementioned ultraviolet ray exposing machine at 0.6 J/cm², and then subjected to post-exposure heating at 80° C. for 5 minutes. The photomask contained 31 arrays of the core exposure pattern shown in FIG. 16 with an interval of 3 mm.

Thereafter, the PET film as the supporting film was released off, and the core pattern was developed with a developer solution (propylene glycol monomethyl ether acetate/N,N-dimethylacetamide=7/3 by mass). Subsequently, the assembly was rinsed with a rinsing liquid (isopropanol) and then dried at 100° C. for 10 minutes, thereby providing the core pattern (step (iii)).

The resin film for forming a cladding layer was then laminated as the upper cladding layer in under the similar lamination conditions as above (step (iv)). A negative photomask providing a width of the bent portion of 1,000 μm as shown in FIG. 16 is disposed, through which the assembly was irradiated with an ultraviolet ray (wavelength: 365 nm) from the aforementioned ultraviolet ray exposing machine at 2 J/cm², and then after releasing the PET film as the supporting film, subjected to post-exposure heating at 80° C. for 10 minutes. The photomask contained 31 arrays of the cladding exposure pattern shown in FIG. 16 with an interval of 3 mm.

Thereafter, the cladding pattern was developed with a developer solution (propylene glycol monomethyl ether acetate/N,N-dimethylacetamide=7/3 by mass). Subsequently, the assembly was rinsed with propylene glycol monomethyl ether acetate as a rinsing liquid and then heated and dried at 80° C. for 10 minutes and at 100° C. for 10 minutes, thereby providing the cladding pattern (step (v)).

The assembly was further irradiated with an ultraviolet ray (wavelength: 365 nm) at 1 J/cm² and then subjected to a heat treatment at 120° C. for 10 minutes and then at 160° C. for 1 hour, thereby forming the upper cladding layer, and thus an optical waveguide having the base film disposed outward was produced. The optical waveguide was then treated under a high temperature and high humidity condition of 85° C. and 85% for 24 hours for releasing the aramid film, and thus the optical waveguide, from which the base film had been removed, was produced.

The state where the core part was embedded in the upper cladding was maintained, and the upper cladding layer had a width of 1,000 μm, which was 50% of the width of the lower cladding layer.

The core layer and the cladding layer were measured for refractive index with a prism coupler (Model 2010, produced by Metricon Corporation), and the refractive index was 1.584 for the core layer and 1.550 for the cladding layer at a wavelength of 830 nm. The optical waveguide thus produced was measured for transmission loss with a surface emission laser of 850 nm (FLS-300-01-VCL, produced by EXFO, Inc.) as a light source, Q82214, produced by Advantest Corporation, using as a light receiving sensor, by the cutback method (measured waveguide length: 10, 5, 3, 2 cm, a GI-50/125 multimode fiber (NA=0.20) as an incoming fiber, and SI-114/125 (NA=0.22) as an outgoing fiber), and the transmission loss was 0.06 dB/cm.

The resulting flexible optical waveguide was measured for tensile elastic modulus and tensile strength in the aforementioned manners, and the flexible optical waveguide had a tensile elastic modulus of 2,000 MPa and a tensile strength of 70 MPa.

### (4) Production of Optoelectronic Circuit Board

### (4-1) Production of Sheet Adhesive

A sheet adhesive containing a protective film, a pressure-sensitive adhesive layer and a light transmissible supporting base material was produced in the same manner as in Example 1.

(4-2) Production of Optical Waveguide with Adhesive Layer

The sheet adhesive, from which the protective film had been released off, was laminated on the flexible optical waveguide produced above with a roll laminator (HLM-1500, produced by Hitachi Chemical Technoplant Co., Ltd.) under condition of a pressure of 0.4 MPa, a temperature of 50° C. and a lamination speed of 0.2 m/min. An ultraviolet ray (365 nm) was radiated on the side of the supporting base material of the adhesive sheet at 250 mJ/cm², thereby releasing the supporting base material off through decrease of the adhesion force at the interface between the pressure-sensitive adhesive layer and the supporting base material, and thus an optical waveguide with an adhesive layer was provided.

### (4-3) Production of Optoelectronic Circuit Board

The optical waveguide with an adhesive layer was disposed on the prescribed position of FPC having an electric circuit pattern (base material: Kapton EN, 12.5 μm, thickness of copper circuit: 5 μm) by positioning with a mask aligner of an ultraviolet ray exposure (MAP-1200-L, produced by Dainippon Screen Mfg. Co., Ltd.), and after vacuuming at 500 Pa or less for 30 seconds with the aforementioned vacuum pressure laminator, press-adhered under condition of a pressure of 0.4 MPa, a temperature of 100° C. and a pressing time of 30 seconds, followed by heating at 180° C. for 1 hour in a clean oven, thereby adhering the flexible optical waveguide and the FPC, and thus an optoelectronic circuit board was provided. The lamination of the optical waveguide and the FPC was performed with the sheets thereof each having 31 arrays of the patterns.

The evaluation with the bending durability tester (produced by Daisho Denshi Co., Ltd.) confirmed bending durability of 100,000 times or more.

### Comparative Example 2

A flexible optical waveguide and an optoelectronic circuit board were produced in the same manner as in Example 3 except that the upper cladding layer was not exposed and developed, but the entire upper cladding layer was cured. The evaluation in the same manner as in Example 3 revealed a transmission loss of 0.05 dB/cm, a tensile elastic modulus of 2,000 MPa and a tensile strength of 70 MPa, which were equivalent to the results in Example 3, but in the bending durability test, the optical waveguide was broken in 10,000 times or less.

### INDUSTRIAL APPLICABILITY

According to the invention, a flexible optical waveguide and an optoelectronic circuit board that are excellent in bending durability (sliding durability) can be produced with good productivity.

### DESCRIPTION OF SYMBOLS

1 flexible optical waveguide
2 first cladding layer (lower cladding layer)
3 first core layer
4 masking film
5 second core layer
6 core layer
7 second cladding layer (upper cladding layer)
8 core pattern
9 photomask
10 resin film for forming cladding layer
11 base film (for forming cladding layer)
12 resin for forming cladding layer
13 protective film
20 resin film for forming core layer
21 base material film (for forming core layer)
22 resin for forming core layer
23 protective film
30 plate laminator
31 pressing member
41 optoelectronic circuit board
42 flexible optical waveguide
43 flexible electric circuit board (FPC)
44 bending axis (virtual axis)

1. A method for producing a flexible optical waveguide, comprising: (I) a step of forming a first cladding layer; (II) a step of forming a first core layer by laminating a resin film for forming a core layer on at least one end portion of the first cladding layer; (III) a step of forming a second core layer by laminating a resin film for forming a core layer on an entire surface of the first core layer and the first cladding layer; (IV) a step of forming a core pattern of the optical waveguide by patterning the first core layer and the second core layer; and (V) a step of embedding the core pattern by forming a second cladding layer on the core pattern and the first cladding layer.

2. A flexible optical waveguide comprising a lower cladding layer, a core part and an upper cladding layer, the upper cladding layer having a width that is smaller than a width of the lower cladding layer at least in a bent portion, and is equal to or smaller than a width of the lower cladding layer in an end portion, and the lower cladding layer having a width in a bent portion that is equal to or smaller than a width thereof in an end portion.

3. A method for producing a flexible optical waveguide, comprising: (i) a step of forming a lower cladding layer; (ii) a step of forming a core layer on the lower cladding layer; (iii) a step of forming a core pattern of the optical waveguide by patterning the core layer; (iv) a step of embedding the core pattern by laminating a resin for forming a cladding layer on the lower cladding layer and the core pattern; and (v) a step of forming an upper cladding layer having a width that is smaller than a width of the lower cladding layer at least in a bent portion, by exposing and developing the resin for forming a cladding layer, while maintaining the core pattern embedded.

4. The method for producing a flexible optical waveguide according to claim 1, wherein in the step (II), the first core layer is provided on both the end portions of the first cladding layer.

5. The method for producing a flexible optical waveguide according to claim 1, wherein in the step (III), after laminating the resin film for forming a core layer on the entire surface of the first core layer and the first cladding layer, a step on the surface thereof is flattened to form a second core layer having a tapered shape.

6. The method for producing a flexible optical waveguide according to claim 5, wherein the flattening was performed with a plate vacuum pressure laminator.

7. The method for producing a flexible optical waveguide according to claim 1, wherein in the step (II), a masking film is disposed on a portion other than at least one end portion of the first cladding layer, the resin film for forming a core layer is laminated on an entire surface of the first cladding layer including a portion having the masking film disposed and a portion having no masking film disposed, and the resin film for forming a core layer on the masking film is removed along with the masking film, thereby forming a first core layer on at least one end portion of the first cladding layer.

8. The method for producing a flexible optical waveguide according to claim 1, wherein in the step (III), the laminating the resin film for forming a core layer is performed with a roll laminator.

9. The method for producing a flexible optical waveguide according to claim 7, wherein in the step (II), the laminating the resin film for forming a core layer is performed with a roll laminator.

10. The method for producing a flexible optical waveguide according to claim 1, wherein in the step (IV), the patterning the first core layer and the second core layer is performed by exposure and development of the first core layer and the second core layer.

11. The method for producing a flexible optical waveguide according to claim 1, wherein the step (I) is a step of using a resin film for forming a cladding layer, and curing a resin of the film, thereby forming the first cladding layer.

12. The method for producing a flexible optical waveguide according to claim 1, wherein the step (V) is a step of using a resin film for forming a cladding layer, and after embedding the core pattern, curing a resin of the resin film for forming a cladding layer, thereby forming the second cladding layer.

13. A flexible optical waveguide produced by the production method according to claim 1.

14. The flexible optical waveguide according to claim 2, wherein, in the bent portion, the width of the upper cladding layer is from 20 to 60% of the width of the lower cladding layer.

15. An optoelectronic circuit board comprising the flexible optical waveguide according to claim 2 laminated on a flexible electric circuit board.
